(19) United States
(12) Patent Application Publication
(10) Pub. No.: US 2015/0112833 A1
(43) Pub. Date: Apr. 23, 2015

(54) SHOPPING SUPPORT SYSTEM

(71) Applicant: TOSHIBA TEC KABUSHIKI KAISHA, Tokyo (JP)

(72) Inventors: Yasutsugu SASAKI, Ohta Tokyo (JP); Kanya HIROI, Yokohama Kanagawa (JP); Mahina NAKAMURA, Musashino Tokyo (JP); Maki SATO, Yokohama Kanagawa (JP); Yumiko OKUMA, Nakano Tokyo (JP); Naoki HOSHINO, Hasuda Saitama (JP)

(21) Appl. No.: 14/480,266

(22) Filed: Sep. 8, 2014

(30) Foreign Application Priority Data
Oct. 23, 2013 (JP) 2013-220638

(51) Int. Cl. G06Q 30/06; G06Q 20/20

(52) U.S. Cl. CPC G06Q 30/0633; G06Q 20/20
USPC 705/26.8; 705/26.1

(57) ABSTRACT

According to an embodiment, a shopping support system has a plurality of customer terminals and a center server. The customer terminal has an input acceptance unit and a customer terminal controller. The input acceptance unit accepts an input of a candidate commodity to become a purchase candidate. The customer terminal controller transmits purchase schedule information including the candidate commodity to the center server. The center server has a center server controller. The center server controller receives the purchase schedule information transmitted from the customer terminal controller, and notifies a store to sell the candidate commodity included in the received purchase schedule information, of the candidate commodity.

### CROSS-REFERENCE TO RELATED APPLICATION

This application is based upon and claims the benefit of priority from the prior Japanese Patent Application No. 2013-220638, filed on Oct. 23, 2013, the entire contents of which are incorporated herein by reference.

### FIELD

Embodiments described herein relate generally to a shopping support system.

### BACKGROUND

Conventionally, a POS (Point Of Sales) terminal to convert a purchase history such as a receipt into electronic data has been proposed. Furthermore, a system to provide the above-described electronized purchase history information to a portable terminal and so on of a customer has been proposed. Furthermore, a shopping list creation device to create a shopping list using a commodity name included in the purchase history information has been proposed.

The above-described shopping list creation device can create a shopping list in which a commodity that a customer purchased in the past is listed as a candidate commodity that the customer will purchase in future, using the conventional technology. However, since the above-described purchase candidate commodity in the above-described shopping list is the commodity purchased in the past, there is a possibility that the purchase candidate commodities are limited. Accordingly there is room for improvement in the conventional technology and device, in the view point of the commodity sales promotion.

### BRIEF DESCRIPTION OF THE DRAWINGS

FIG. 1 is a diagram showing a shopping support system according to a first embodiment.

FIG. 2 is a block diagram showing the customer terminal included in the shopping support system according to the first embodiment.

FIG. 3 is a block diagram showing the center server included in the shopping support system according to the first embodiment.

FIG. 4 is a diagram showing the shopping list management table of the center server included in the shopping support system according to the first embodiment.

FIG. 5 is a diagram showing the first purchase history management table of the center server included in the shopping support system according to the first embodiment.

FIG. 6 is a block diagram showing the store server included in the shopping support system according to the first embodiment.

FIG. 7 is a diagram showing the commodity management table of the store server included in the shopping support system according to the first embodiment.

FIG. 8 is a diagram showing the purchase commodity management table of the store server included in the shopping support system according to the first embodiment.

FIG. 9 is a block diagram showing the POS terminal included in the shopping support system according to the first embodiment.

FIG. 10 is a block diagram showing the signage terminal included in the shopping support system according to the first embodiment.

FIG. 11 is a flow chart showing a first creation support processing which the shopping support system according to the first embodiment executes.

FIG. 12 is a diagram showing an example of a shopping list creation screen which the customer terminal included in the shopping support system according to the first embodiment displays.

FIG. 13 is a diagram showing an example of a shopping list creation screen which the customer terminal included in the shopping support system according to the first embodiment displays.

FIG. 14 is a diagram showing an example of a shopping list creation screen which the customer terminal included in the shopping support system according to the first embodiment displays.

FIG. 15 is a diagram showing an example of a detailed screen of the candidate commodity which the customer terminal included in the shopping support system according to the first embodiment displays.

FIG. 16 is a diagram showing an example of a shopping list screen which the customer terminal included in the shopping support system according to the first embodiment displays.

FIG. 17 is a diagram showing an example of a shopping list screen which the customer terminal included in the shopping support system according to the first embodiment displays.

FIG. 18 is a diagram showing an example of a shopping list screen which the customer terminal included in the shopping support system according to the first embodiment displays.

FIG. 19 is a flow chart showing a second creation support processing which the shopping support system according to the first embodiment executes.

FIG. 20 is a diagram showing an example of a shopping list screen which the customer terminal included in the shopping support system according to the first embodiment displays.

FIG. 21 is a diagram showing an example of a shopping list screen which the customer terminal included in the shopping support system according to the first embodiment displays.

FIG. 22 is a flow chart showing a shopping support processing which the shopping support system according to the first embodiment executes.

FIG. 23 is a diagram showing an example of a privilege imparting screen which the customer terminal included in the shopping support system according to the first embodiment displays.

FIG. 24 is a diagram showing an example of a shopping support screen which the customer terminal included in the shopping support system according to the first embodiment displays.

FIG. 25 is a flow chart showing a commodity sales data processing which the shopping support system according to the first embodiment executes.

FIG. 26 is a flow chart showing a candidate commodity erasing processing which the shopping support system according to the first embodiment executes.

FIG. 27 is a flow chart showing an analysis processing which the shopping support system according to the first embodiment executes.

### DETAILED DESCRIPTION

According to an embodiment, a shopping support system has a plurality of customer terminals and a center server. The shopping support system further has an input acceptance unit provided in the customer terminal, a customer terminal controller provided in the customer terminal, and a center server controller provided in the center server. The input acceptance unit of the customer terminal accepts an input of a candidate commodity to become a purchase candidate. The customer terminal controller transmits purchase schedule information including the candidate commodity accepted by the input acceptance unit of the customer terminal, to the center server. The center server controller receives the purchase schedule information transmitted from the customer terminal controller. Furthermore, the center server controller notifies a store to sell the candidate commodity included in the received purchase schedule information, of the candidate commodity.

Hereinafter, a shopping support system according to a first embodiment will be described with reference to the drawings. In the drawings, the same symbols show the same or similar portions. The embodiment is not limited to the following description.

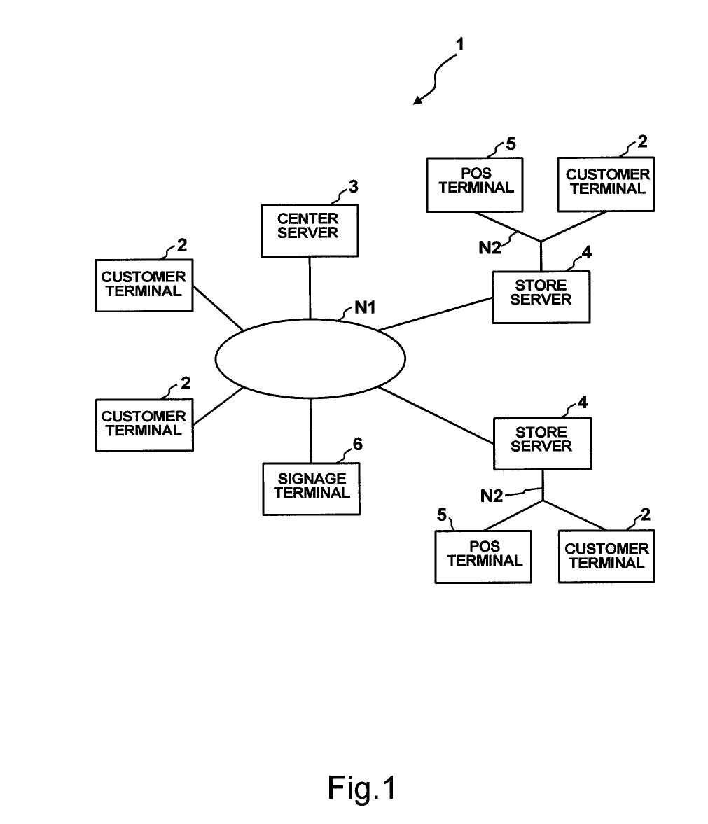

A whole configuration of a shopping support system according to a first embodiment will be described with reference to FIG. 1. FIG. 1 is a diagram showing a shopping support system 1 according to a first embodiment. The shopping support system 1 has customer terminals 2, a center server 3, store servers 4, POS terminals 5, a signage terminal 6. The customer terminal 2, the store server 4, the signage server 6 and the center server 3 connect to each other via a network N1 such as a public line or Internet. Accordingly, the customer terminal 2, the store server 4, the signage server 6 and the center server 3 can communicate with each other via the network N1. The store server 4, the POS terminal 5, the customer terminal 2 connect to each other via a network N2 such as a LAN provided in a store. Accordingly, the store server 4, the POS terminal 5, the customer terminal 2 can communicate with each other via the network N2. The numbers of the customer terminals 2, the store servers 4, the POS terminals 5 and the signage terminals 6 are not limited to the numbers of the example of FIG. 1, respectively.

The customer terminal 2 is an information processing unit such as a tablet terminal and a smartphone which an operator operates. In the following description, an operator of the customer terminal 2, an operator of a signage terminal described later, and a store user who purchases a commodity in a store, for example are generally called customers. The customer terminal 2 cooperates with the center server 3 and so on, to support creation of a shopping list by a customer. The shopping list is a list in which a commodity of a purchase candidate of a customer (hereinafter, called a candidate commodity) is recorded, for example. Specifically, the shopping list is a list of the candidate commodity inputted by the customer according to an input mode described latter. Furthermore, the customer terminal 2 cooperates with the store server 4 and so on, to support the shopping of a candidate commodity by a customer based on the shopping list.

The center server 3 is a server device installed in a data center, for example. The center server 3 stores various data pertaining to a customer and a store, in order to manage the various data pertaining to the customer and the store. Furthermore, the center sever 3 mediates information exchange between the customer terminal 2 and the store server 4, and information exchange between the customer terminal 2 and the signage terminal 6. The number of stores (store servers 4) connected to the center server 3 is not limited.

The store server 4 is a server device which is installed in each store. The store server 4 executes analysis processing pertaining to sales management and sales strategy of commodities sold in the store. In the following description, a commodity sold in a store is simply called a sales commodity. Furthermore, the store server 4 provides various information such as an electronic coupon and an advertisement, relating to the above-described candidate commodity or the above-described sales commodity to the customer terminal 2, through the center server 3 and so on.

The POS terminal 5 is a commodity sales data processing unit which is installed in a store of each store. The POS terminal 5 accepts an operation by an employee of the store. The POS terminal 5 accepts the operation by the employee of the store, to accept a sales input of a sales commodity which a customer purchases. The POS terminal 5 accepts the sales input, to perform sales registration of the sales commodity which the customer purchases. The POS terminal 5 outputs purchase history information including transaction content of the registered sales. The number of the POS terminals 5 installed in each store is not limited.

The signage terminal 6 is a signage terminal which provides a guide and advertisement information for advertising a specific store and sales commodity to an unspecified large number of customers. In the following description, the above-described guide and advertisement information may be called a digital signage. The signage terminal 6 is installed inside a station or in a town, for example, where an unspecified large number of customers are present. The signage terminal 6 carries out a display output and a sound output relating to a digital signage.

Hereinafter, configurations of the above-described respective devices included in the shopping support system 1 will be described.

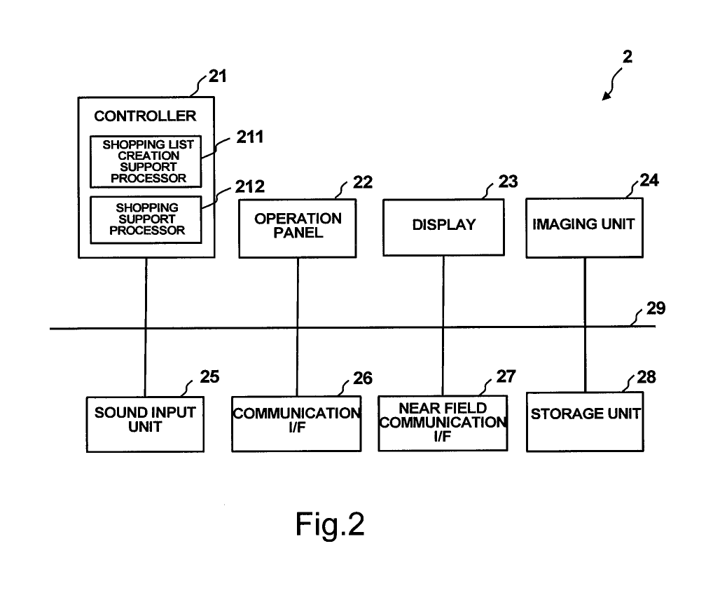

A configuration of the customer terminal 2 will be described with reference to FIG. 2. FIG. 2 is a block diagram showing the customer terminal 2. As shown in FIG. 2, the customer terminal 2 has a controller 21. The controller 21 executes various calculations, and integrated control of the respective units of the customer terminal 2. The controller 21 is a computer including a CPU (Central Processing Unit), a RAM (Random Access Memory), a ROM (Read Only Memory), and an RTC (Real Time Clock) unit, and so on. The RAM is a main storage device of the controller 21. The ROM stores various programs and data. The RTC unit clocks current date and time.

The customer terminal 2 further has an operation panel 22 and a display 23. The operation panel 22 and the display 23 connect to the controller 21 via a bus 29. The operation panel 22 has an operation key and an operation button, for example, to accept an operation input by a customer. The display 23 is a liquid crystal display, for example. The display 23 displays various information such as a name of a candidate commodity. The display 23 is a display of a touch panel type, and functions also as the operation panel 22.

The customer terminal 2 further has an imaging unit 24 and a sound input unit 25. The imaging unit 24 and the sound input unit 25 connect to the controller 21 via the bus 29. The imaging unit 24 has an imaging element such as a CCD (Charge Coupled Device) or a CMOS (Complementary Metal-Oxide Semiconductor). The imaging unit 24 images various photographic subjects. The imaging unit 24 images a code symbol of a candidate commodity described later, and an image of the candidate commodity, and so on, as the photographic subject, for example. The sound input unit 25 is a sound collecting device such as a microphone. The sound input unit 25 accepts an input of sound.

The customer terminal 2 further has a communication I/F (interface) 26 and a near field communication I/F 27. The communication I/F 26 and the near field communication I/F 27 connect to the controller 21 via the bus 29. The communication I/F 26 is connectable to the network N1. The communication I/F 26 is a transmission unit to transmit various information to the center server 3 and so on. Furthermore, the communication I/F 26 is a receiving unit to receive various information from the center server 3 and so on. In other words, the communication I/F 26 doubles as the transmission unit and the receiving unit. However, the communication I/F 26 is not limited to this configuration. For example, the customer terminal 2 may have the communication I/Fs 26 separately as the transmission unit and the receiving unit. The controller 21 performs exchange of various information with the center server 3 and so on, using the communication I/F 26. The near field communication I/F 27 is a near field communication interface which is based on a standard such as NFC (Near Field Communication). The near field communication I/F 27 is a transmission unit to transmit various information to the POS terminal 5 and the signage terminal 6 and so on. Furthermore, the near field communication I/F 27 is a receiving unit to receive various information from the POS terminal 5 and the signage terminal 6 and so on. In other words, the near filed communication I/F 27 doubles as the transmission unit and the receiving unit. However, the near filed communication I/F 27 is not limited to this configuration. For example, the customer terminal 2 may have the near filed communication I/Fs 27 separately as the transmission unit and the receiving unit. The controller 21 performs exchange of various information with a device which can perform near field communication, such as the POS terminal 5 and the signage terminal 6 and so on, using the near field communication I/F 27.

The customer terminal 2 further has a storage unit 28. The storage unit 28 connects to the controller 21 via the bus 29. The storage unit 28 is an auxiliary storage device, such as an HDD (Hard Disk Drive) or an SSD (Solid State Drive). The storage unit 28 stores various programs which the controller 21 executes. The storage unit 28 further stores various data, such as purchase schedule information, additional information and display screen information.

The controller 21 of the customer terminal 2 further includes a shopping list creation support processor 211 and a shopping support processor 212, as shown in FIG. 2. The shopping list creation support processor 211 and the shopping support processor 212 cooperates with the program stored in the ROM or the storage unit 28, to execute a processing for realizing a prescribed function. Processings which the shopping list creation support processor 211 and the shopping support processor 212 execute will be described later.

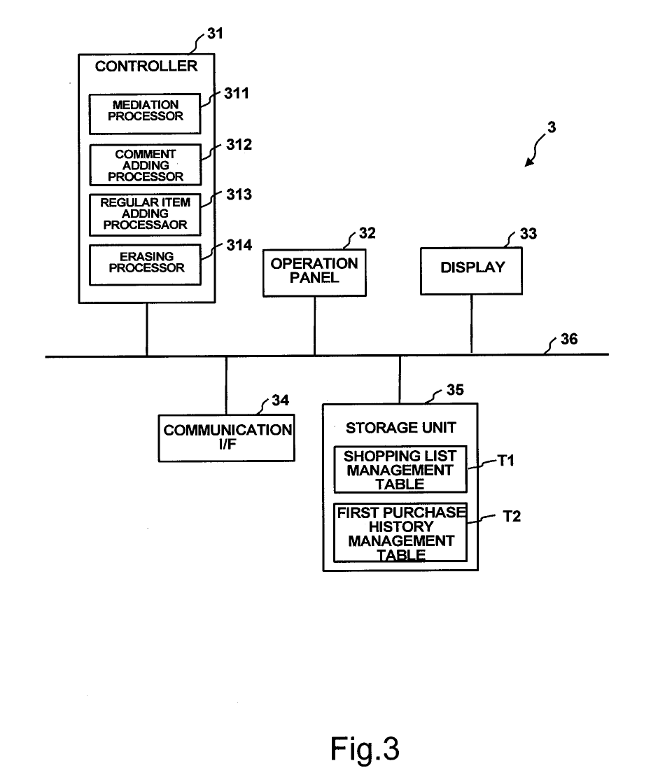

A configuration of the center server 3 will be described with reference to FIG. 3 to FIG. 5. FIG. 3 is a block diagram showing the center server 3. As shown in FIG. 3, the center server 3 has a controller 31. The controller 31 executes various calculations, and integrated control of the respective units of the center server 3. The controller 21 is a computer including a CPU, a RAM, a ROM, and an RTC unit and so on. The RAM is a main storage device of the controller 31. The ROM stores various programs and data. The RTC unit clocks current date and time.

The center server 3 further has an operation panel 32 and a display 33. The operation panel 32 and the display 33 connect to the controller 31 via a bus 36. The operation panel 32 has a key board and a pointing device, for example, to accept an operation input by an operator of the center server 3. The display 33 is a liquid crystal display, for example. The display 33 displays various information.

The center server 3 further has a communication I/F 34. The communication I/F 34 connects to the controller 31 via the bus 36. The communication I/F 34 is connectable to the network N1. The communication I/F 34 is a transmission unit to transmit various information to the customer terminal 2, the store server 4 and the signage terminal 6 and so on. Furthermore, the communication I/F 34 is a receiving unit to receive various information from the customer terminal 2, the store server 4 and the signage terminal 6 and so on. In other words, the communication I/F 34 doubles as the transmission unit and the receiving unit. However, the communication I/F 34 is not limited to this configuration. For example, the center server 3 may have the communication I/Fs 34 separately as the transmission unit and the receiving unit. The controller 31 performs exchange of various information with the customer terminal 2, the store server 4 and the signage terminal 6 and so on, using the communication I/F 34.

The center server 3 further has a storage unit 35. The storage unit 35 connects to the controller 31 via the bus 36. The storage unit 35 is an auxiliary storage device, such as an HDD or an SSD. The storage unit 35 stores various programs which the controller 31 executes, and various data. The storage unit 35 further has a shopping list management table T1 and a first purchase history management table T2, in order to store data relating to a customer and a store.

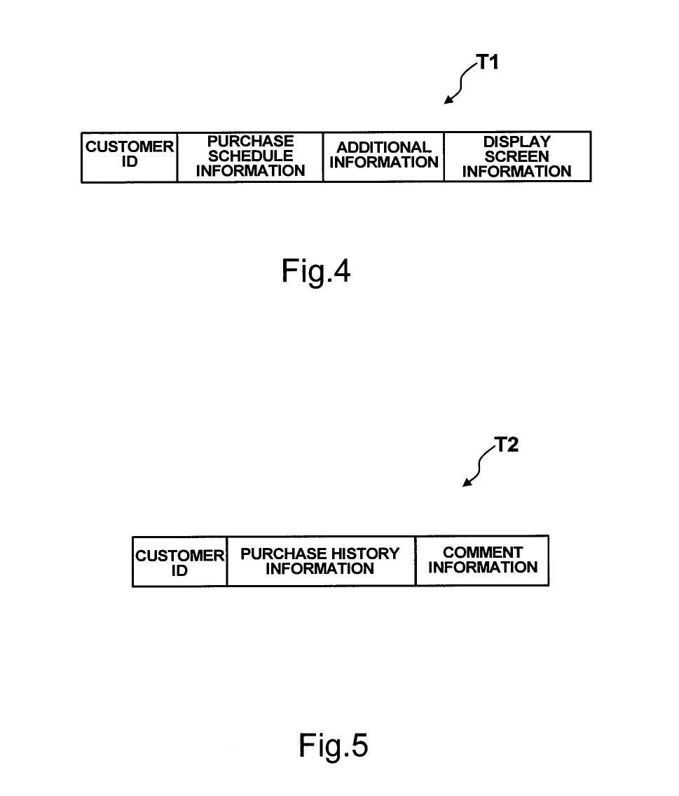

FIG. 4 is a diagram showing storage content of the shopping list management table T1. As shown in FIG. 4, the shipping list management table T1 stores a customer ID. In addition, the shopping list management table T1 stores the purchase schedule information, the additional information and the display screen information and so on, corresponding to the customer ID. The customer ID is identification information of a customer for identifying each customer. The customer ID is previously assigned to a customer, after a customer takes a procedure for member registration and so on, for example.

The purchase schedule information includes information of a candidate commodity. The information of a candidate commodity includes a commodity name of the candidate commodity and a commodity ID of the candidate commodity, and so on. The commodity name includes a concrete name and a common name. The concrete name is a concrete name indicating a specific commodity. The common name is not a name indicating a specific commodity, but is a general name such as a classification name or a category name of a commodity. The commodity ID is identification information of a commodity capable of identifying each commodity. The commodity ID is a JAN code, for example. The additional information is information which is added to a candidate commodity included in the purchase schedule information. The additional information includes an electronic coupon instructing to impart privilege such as a discount and point imparting, and advertisement information to advertise (advertise) a specific store and commodity. When the additional information is added to a specific candidate commodity, the shopping list management table T1 stores the additional information, corresponding to the commodity ID or the commodity name of the relevant candidate commodity.

The above-described display screen information is information for realizing (reproducing) a display state of a shopping list created on a display screen of the display 23 of the customer terminal 2. The display screen information includes information relating to a display layout of the display 23, and image data such as a handwritten character described later.

FIG. 5 is a diagram showing storage content of the first purchase history management table T2. As shown in FIG. 5, the first purchase history management table T2 stores a customer ID. In addition, the first purchase history management table T2 stores the purchase history information and so on corresponding to the customer ID. The purchase history information is information indicating a history of commodities which the customer corresponding to the customer ID has purchased. In the following description, out of the above-described sales commodities, a commodity which the customer has purchased may simply be called a purchase commodity. The purchase history information includes a store ID showing a store which is a commodity purchase destination of a customer, a purchase date and time (transaction date and time) when the commodity was purchased by the customer, commodity information of each purchase commodity, for example. The store ID is identification information of a store capable of identifying each store. The commodity information includes a name of a commodity, a commodity ID, and a unit price of the commodity.

Furthermore, the first purchase history management table T2 stores comment information, corresponding to the commodity information of a purchase commodity included in the purchase history information. Specifically, the first purchase history management table T2 stores the comment information, corresponding to the commodity ID of the purchase commodity. The comment information is various information relating to a specific commodity registered, by an input of a customer from the customer terminal 2. The comment information includes a comment of a customer and an evaluation by a customer and so on relating to a specific commodity. The comment information is registered by the input of the customer, corresponding to the commodity ID of the specific commodity.

The controller 31 of the center server 3 further includes a mediation processor 311, a comment adding processor 312, a regular item adding processor 313 and an erasing processor 314, for example, as shown in FIG. 3. Each of the processors 311-314 cooperates with a program stored in the ROM or the storage unit 35, to execute a processing for realizing a prescribed function. The processing which each of the processors 311-314 executes will be described later.

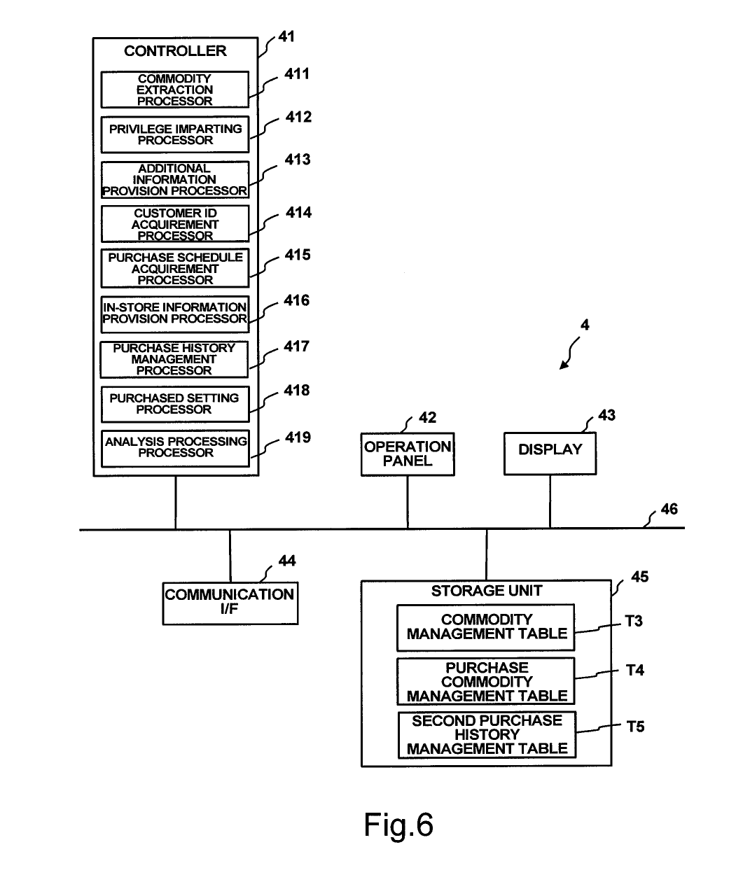

A configuration of the store server 4 will be described with reference to FIG. 6 to FIG. 8. FIG. 6 is a block diagram showing the store server 4. As shown in FIG. 6, the center server 4 has a controller 41. The controller 41 executes various calculations, and integrated control of the respective units of the store server 4. The controller 41 is a computer including a CPU, a RAM, a ROM, and an RTC unit and so on. The RAM is a main storage device of the controller 41. The ROM stores various programs and data. The RTC unit clocks current date and time.

The store server 4 further has an operation panel 42 and a display 43. The operation panel 42 and the display 43 connect to the controller 31 via a bus 46. The operation panel 2 has a key board and a pointing device, for example, to accept an operation input by an employee of the store. The display 43 is a liquid crystal display, for example. The display 43 displays various information.

The store server 4 further has a communication I/F 44. The communication I/F 44 connects to the controller 41 via the bus 46. The communication I/F 44 is connectable to the network N1 and the network N2. The communication I/F 44 is a transmission unit to transmit various information to the center server 3 and the POS terminal 5 and so on. Furthermore, the communication I/F 44 is a receiving unit to receive various information from the center server 3 and the POS terminal 5 and so on. In other words, the communication I/F 44 doubles as the transmission unit and the receiving unit. However, the communication I/F 44 is not limited to this configuration. For example, the store server 4 may have the communication I/Fs 44 separately as the transmission unit and the receiving unit. The controller 41 performs exchange of various information with the center server 3 and the POS terminal 5 and so on, using the communication I/F 44.

The store server 4 further has a storage unit 45. The storage unit 45 connects to the controller 41 via the bus 46. The storage unit 45 stores various programs which the controller 41 executes, and various data. The storage unit 45 further has a commodity management table T3, a purchase commodity management table T4, and a second purchase history management table T5.

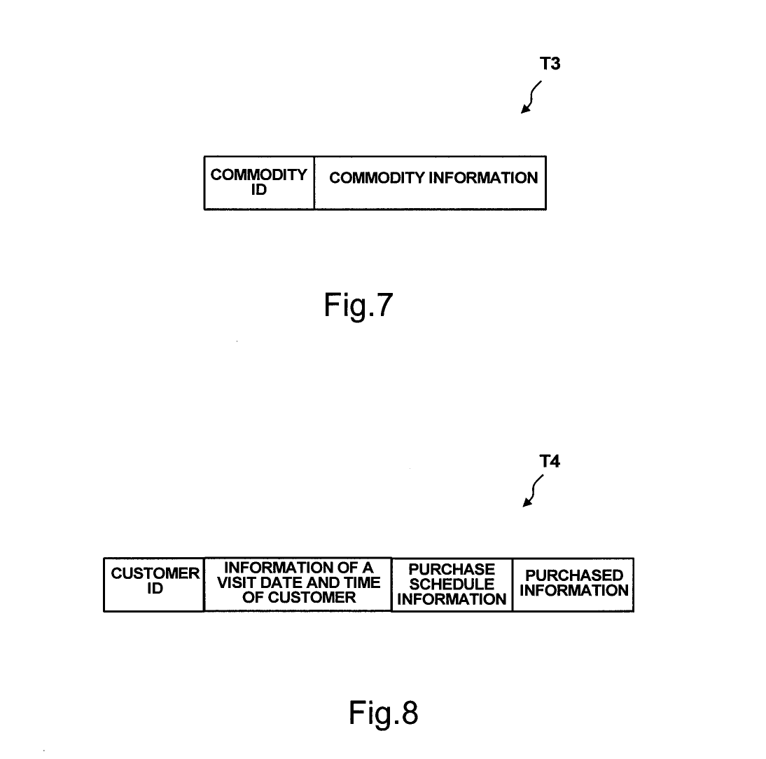

FIG. 7 is a diagram showing storage content of the commodity management table T3. As shown in FIG. 7, the commodity management table T3 stores a commodity ID of each sales commodity. Furthermore, the commodity management table T3 stores commodity information and so on of the sales commodity, corresponding to the commodity ID of each sales commodity. The commodity information of the sales commodity is information relating to a sales commodity which is sold in a store. The commodity information which the commodity management table T3 stores, includes image data such as a photograph and an illustration representing the commodity, in addition of a commodity name and a unit price of the commodity.

FIG. 8 is a diagram showing storage content of the purchase commodity management table T4. As shown in FIG. 8, the purchase commodity management table T4 stores a customer ID. In addition, the purchase commodity management table T4 stores information of a visit date and time of the customer, and the purchase schedule information, corresponding to the customer ID. The information of a visit date and time includes a date and time when the customer corresponding to the customer ID visited the store. In addition, the purchase commodity management table T4 stores purchased information, corresponding to each candidate commodity included in the purchase schedule information. Specifically, the purchase commodity management table T4 stores purchased information, corresponding to the commodity ID of the candidate commodity, for example. The purchased information is flag information and so on showing whether or not the candidate commodity has been actually purchased.

The second purchase history management table T5 stores the above-described purchase history information. Specifically, the second purchase history management table T5 stores the purchase history information and so on except the comment information out of the storage content of the first purchase history management table T2 shown in FIG. 5. However, the above-described first purchase history management table T2 stores the purchase history information, in order to manage collectively the purchase history information of a plurality of stores (store servers 4) connected to the center server 3 via the network N1. On the other hand, the second purchase history management table T5 stores the purchase history information in order to manage the purchase history information of the own store.

The controller 41 of the store server 4 further includes a commodity extraction processor 411, a privilege imparting processor 412, an additional information provision processor 413, a customer ID acquisition processor 414, a purchase schedule acquirement processor 415, an in-store information provision processor 416, a purchase history management processor 417, a purchased setting processor 418 and an analysis processing processor 419. Each of the processors 411-419 cooperates with a program stored in the ROM of the storage unit 45, to execute a processing for realizing a prescribed function. The processing which each of the processors 411-419 executes will be described later.

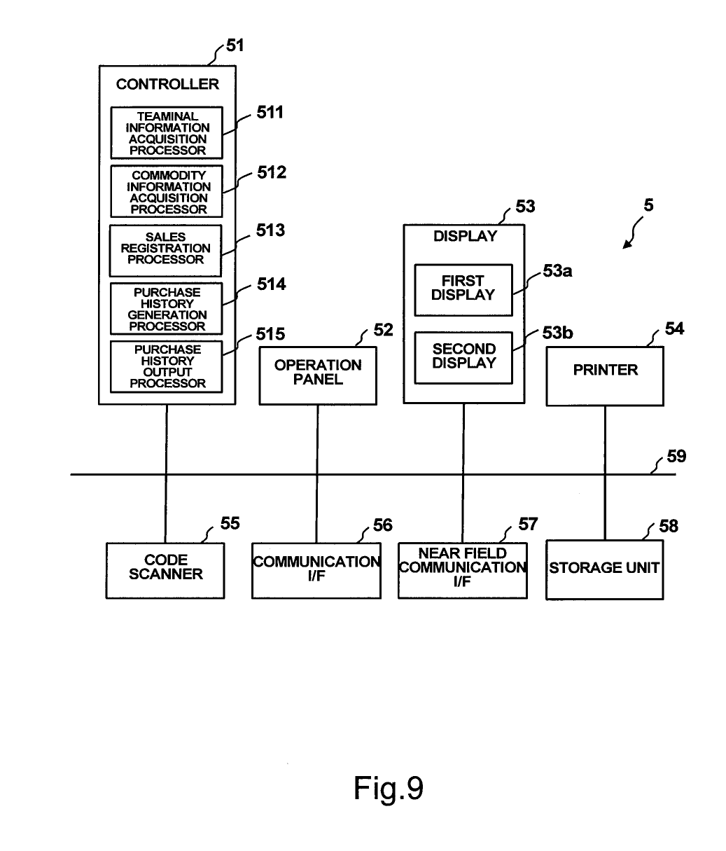

A configuration of the POS terminal 5 will be described with reference to FIG. 9. FIG. 9 is a block diagram showing the POS terminal 5. As shown in FIG. 9, the POS terminal 5 has a controller 51. The controller 51 executes various calculations, and integrated control of the respective units of the POS terminal 5. The controller 51 is a computer including a CPU, a RAM, a ROM, and an RTC unit and so on. The RAM is a main storage device of the controller 51. The ROM stores various programs and data. The RTC unit clocks current date and time.

The POS terminal 5 further has an operation panel 52, a display 53, a printer 54 and a code scanner 55. The operation panel 52, the display 53, the printer 54 and the code scanner 55 connect to the controller 51 via a bus 59.

The operation panel 52 has various operation keys. The operation keys include a register key, a cursor key, a selection determination key, a subtotal key, and a settlement key and so on, for example. The register key accepts an input of a numerical value by an employee of the store, for example. The cursor key and the selection determination key accept a selection input of a prescribed item by an employee of the store. The subtotal key accepts an operation input by an employee of the store, so as to instruct outputting a total amount of money of the commodities in which registrations of the sales are performed. The settlement key accepts an operation input by an employee of the store, so as to declare price settlement, by performing settlement processing of one transaction.

The display 53 is a liquid crystal display, for example. The display 53 displays various information, such as a commodity name and a commodity price of the commodity in which the above-described registration of the sales has been performed, a total sum of money of the one transaction in which the above-described settlement has been declared, an amount of a change. The display 53 has a first display 53a and a second display 53b. The first display 53a displays various information for an employee (cashier) of the store. The second display 53b displays various information for a customer. The display 53 may be a display of a touch panel type. When the display 53 is a display of a touch panel type, the display 53 can double as the operation panel 52.

The printer 54 is a printer device which performs printing of a receipt and a journal and so on. The code scanner 55 is a scanner device which optically reads a code symbol such as a bar code and a two-dimensional code. The code symbol is a bar code or a two-dimensional code, and so on attached to a commodity, for example. The code scanner 55 reads a code symbol attached to a commodity, for example. The code scanner 55 further reads a code symbol displayed on the customer terminal 2, for example. The code scanner 55 reads a code symbol, to output information held in the code symbol to the controller 51. A code symbol attached to a commodity holds a commodity ID and so on which can discriminate the commodity, for example.

The POS terminal 5 further has a communication I/F 56 and a near field communication I/F 57. The communication I/F 56 and the near field communication I/F 57 connect to the controller 51 via the bus 59. The communication I/F 56 is connectable to the network N2. The communication I/F 56 is a transmission unit to transmit various information to the store server 4 and so on. Furthermore, the communication I/F 56 is a receiving unit to receive various information from the store server 4 and so on. In other words, the communication I/F 56 doubles as the transmission unit and the receiving unit. However, the communication I/F 56 is not limited to this configuration. For example, the POS terminal 5 may have the communication I/Fs 56 separately as the transmission unit and the receiving unit. The controller 51 performs exchange of various information with the store server 4 and so on, using the communication I/F 56. The near field communication I/F 57 is a near field communication interface which is based on a standard such as NFC. The near field communication I/F 57 is a transmission unit to transmit various information to the customer terminal 2 and so on. Furthermore, the near field communication I/F 57 is a receiving unit to receive various information from the customer terminal 2 and so on. In other words, the near filed communication I/F 57 doubles as the transmission unit and the receiving unit. However, the near filed communication I/F 57 is not limited to this configuration. For example, the POS terminal 5 may have the near filed communication I/Fs 57 separately as the transmission unit and the receiving unit. The controller 51 performs exchange of various information with a device which can perform near field communication, such as the customer terminal 2 and so on, using the near field communication I/F 57.

The POS terminal 5 further has a storage unit 58. The storage unit 58 is an auxiliary storage device, such as an HDD or an SSD. The storage unit 28 stores a program for executing various POS affairs including commodity sales data processing described later, and various data. Furthermore, the storage unit 28 previously stores the store ID and so on of the own store.

The controller 51 of the POS terminal 5 further includes a terminal information acquisition processor 511, a commodity information acquisition processor 512, a sales registration processor 513, a purchase history generation processor 514, and a purchase history output processor 515, as shown in FIG. 9. Each of the processors 511-515 cooperates with a program stored in the ROM or the storage unit 58, to execute a processing for realizing a prescribed function. The processing which each of the processors 511-515 executes will be described later.

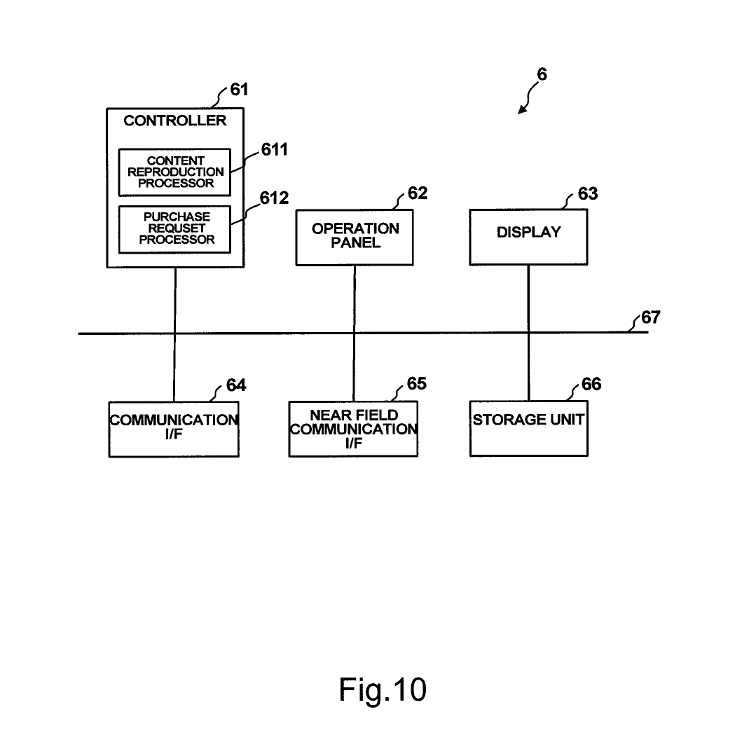

A configuration of the signage terminal 6 will be described with reference to FIG. 10. FIG. 10 is a block diagram showing the signage terminal 6. As shown in FIG. 10, the signage terminal 6 has a controller 61. The controller 61 executes various calculations, and integrated control of the respective units of the signage terminal 6. The controller 61 is a computer having a CPU, a RAM, a ROM, and an RTC unit. The RAM is a main storage device of the controller 61. The ROM stores various programs and data. The RTC unit clocks current date and time.

The signage terminal 6 further has an operation panel 62 and a display 63. The operation panel 62 and the display 63 connect to the controller 61 via a bus 67. The operation panel 62 has a key board and a pointing device which accept an operation by a customer, for example. The display 63 is a liquid crystal display, for example. The display 63 has a display function to display the above-described digital signage, and a sound output function to output sound relating to the above-described digital signage. The display 63 may be a display of a touch panel type. When the display 63 is a display of a touch panel type, the display 63 can double as the operation panel 62.

The signage terminal 6 further has a communication I/F 64 and a near field communication I/F 65. The communication I/F and the near field communication I/F 65 connect to the controller 61 via the bus 67. The communication I/F 64 is connectable to the network N1. The communication I/F 64 is a transmission unit to transmit various information to the center server 3 and so on. Furthermore, the communication I/F 56 is a receiving unit to receive various information from the center server 3 and so on. In other words, the communication I/F 64 doubles as the transmission unit and the receiving unit. However, the communication I/F 64 is not limited to this configuration. For example, the signage terminal 6 may have the communication I/Fs 64 separately as the transmission unit and the receiving unit. The controller 61 performs exchange of various information with the center server 3 and so on, using the communication I/F 64. The near field communication I/F 65 is a near field communication interface which is based on a standard such as NFC. The near field communication I/F 65 is a transmission unit to transmit various information to the customer terminal 2 and so on. Furthermore, the near field communication I/F 65 is a receiving unit to receive various information from the customer terminal 2 and so on. In other words, the near filed communication I/F 65 doubles as the transmission unit and the receiving unit. However, the near filed communication I/F 65 is not limited to this configuration. For example, the signage terminal 6 may have the near filed communication I/Fs 65 separately as the transmission unit and the receiving unit. The controller 61 performs exchange of various information with a device which can perform near field communication, such as the customer terminal 2 and so on, using the near field communication I/F 65.

The signage terminal 6 further has a storage unit 66. The storage unit 66 connects to the controller 61 via the bus 67. The storage unit 66 is an auxiliary storage device, such as an HDD or an SSD. The storage unit 66 stores various programs which the controller 61 executes, and various data such as content data pertaining to the digital signage. The content data includes image data and sound data.

The controller 61 of the signage terminal 6 further includes a content reproduction processor 611 and a purchase request processor 612, as shown in FIG. 10. Each of the content reproduction processor 611 and the purchase request processor 612 executes a processing for realizing a prescribed function. Processings which the content reproduction processor 611 and the purchase request processor 612 execute will be described later.

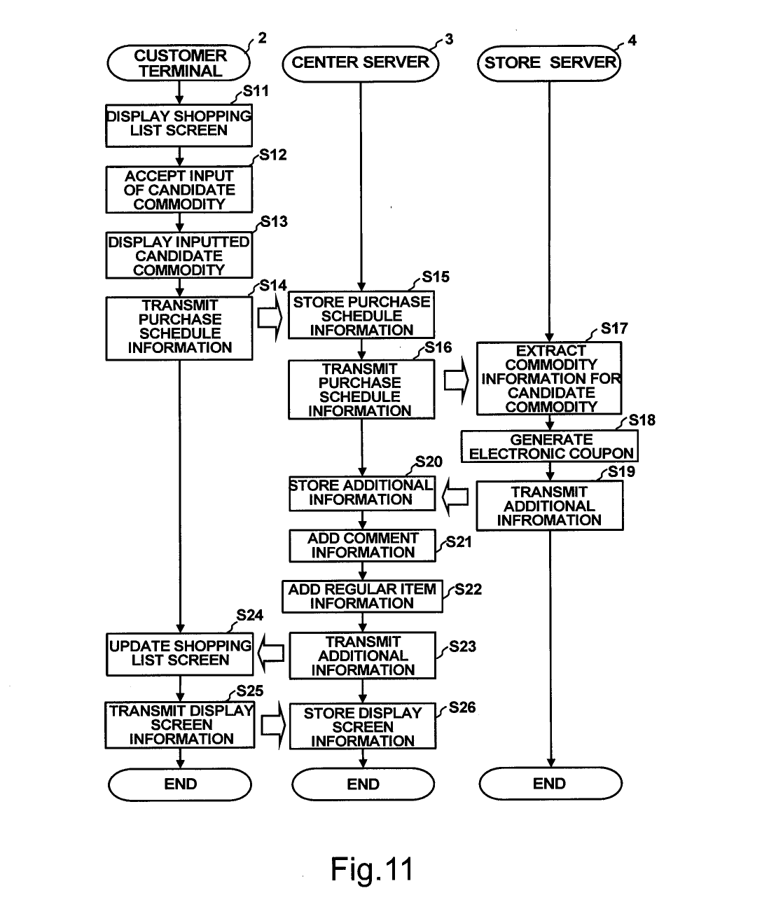

Hereinafter, processings which the respective devices of the shopping support system 1 execute will be described including processings which the processors of the respective devices execute. To begin with, a first creation support processing pertaining to creation of a shopping list will be described with reference to FIG. 11 to FIG. 18. This first creation support processing is a processing for adding a commodity which is inputted by the customer terminal 2 to a shopping list as a candidate commodity.

FIG. 11 is a flow chart showing a first creation support processing by the shopping support system 1. In the first creation support processing, the shopping list creation support processor 211 of the customer terminal 2 provides various GUIs (Graphical User Interface), such as a shopping list screen and so on described later, to a customer who is an operator of the customer terminal 2.

Specifically, as shown in FIG. 11, in a processing step S11 of the customer terminal 2, the shopping list creation support processor 211 of the customer terminal 2 displays a shopping list creation screen G100 including a shopping list screen G1, using the display 23. For example, the shopping list creation support processor 211 controls the display operation of the display 23, so as to display the shopping list creation screen G100, using the display 23. The display is controlled by the shopping list creation support processor 211, to display the shopping list creation screen G100. At the time of a log-in to the customer terminal 2 by a customer, or when the display 23 displays the shopping list creation screen G100, and so on, the operation panel 22 accepts a customer ID inputted by the customer, for example. Accompanied with the input of the customer ID by the customer, the customer terminal 2 notifies the center server 3 of information (an IP address and so on, for example) with which the customer accesses to the own device, along with the above-described accepted customer ID, using the communication I/F 26. For example, the shopping list creation support processor 211 of the customer terminal 2 controls the communication operation of the communication I/F 26, so as to notify the center server 3 of the above-described access information and customer ID to the center server 3, using the communication I/F 26. The communication I/F 26 is controlled by the shopping list creation support processor 211, to transmit the above-described access information and customer ID to the center server 3.

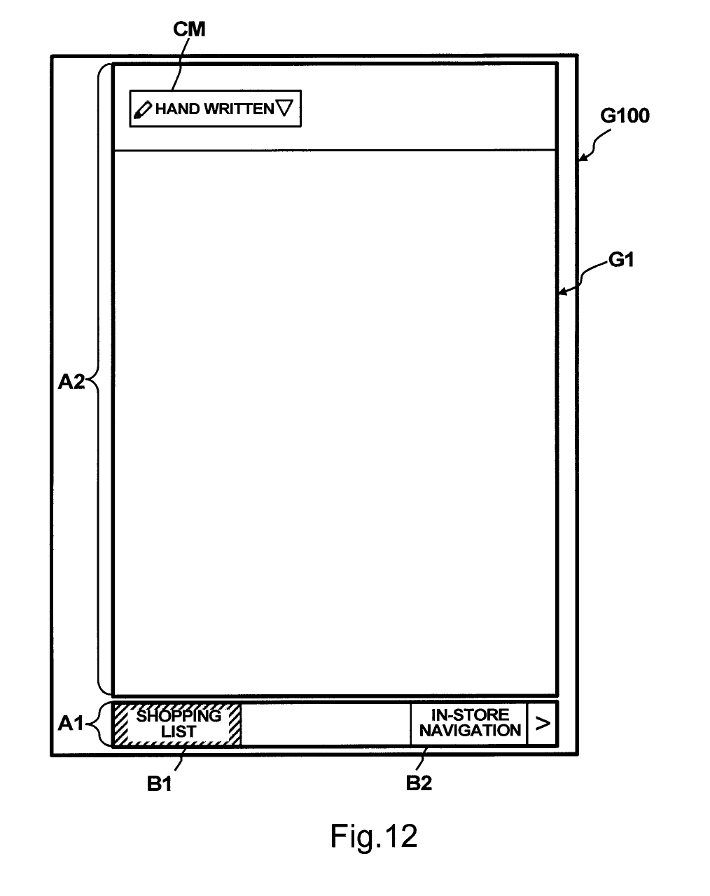

FIG. 12 is a diagram showing the above-described shopping list creation screen G100 in the above-described step S11. As shown in FIG. 12, the shopping list creation screen G100 has a first area A1 and a second area A2. In the first area A1, an operator for switching a display mode of the screen displayed in the second area A2 is displayed. In other words, the display 23 is controlled by the shopping list creation support processor 211, to display the operator for switching the above-described display mode, in the first area A1. In the second area A2, various screens such as the shopping list screen G1 are displayed. In other words, the display 23 is controlled by the shopping list creation support processor 211, to display various screens such as the shopping list screen G1 in the second area A2.

In the above-described step S11, the operators for switching the above-described display mode include a button B1 and a button B2, and so on, as shown in FIG. 12. The button B1 is an operator to accept a touch operation by a customer, so as to switch the screen to be displayed in the above-described second area A2 to the shopping list screen G1. In the button B1, a character string of “SHOPPING LIST”, for example, is displayed, so as to guide the function of the button to a customer. The button B2 is an operator to accept a touch operation by a customer, so as to switch the screen to be displayed in the above-described second area A2 to a shopping support screen G4. In the button B2, a character string of “IN-STORE NAVIGATION”, for example, is displayed, so as to guide the function of the button to a customer.

When the button B1 accepts a touch operation (selection) by a customer, the shopping list creation support processor 211 controls the display operation of the display 23, so as to display the shopping list screen G1 in the above-described second area A2, using the display 23. The display 23 is controlled by the shopping list creation support processor 211, to display the shopping list screen G1 in the second area A2 of the shopping list creation screen G100, as shown in FIG. 12. The shopping list screen G1 displays a shopping list and a switching menu button CM. The shopping list is a list of the candidate commodity inputted by a customer. The switching menu button CM is an operator which accepts a touch operation by a customer, so as to switch an input mode by a customer for the shopping list screen G1. When the switching menu button CM accepts the touch operation by the customer for selecting a desired input mode, the shopping list creation support processor 211 accepts input of a candidate commodity with a method according to the input mode selected by the customer for creating the shopping list.

Specifically, the input mode has a handwritten character input mode, a sound input mode, a key input mode, a code input mode, and an image input mode, for example. The handwritten character input mode is an input mode by a handwritten character. The sound input mode is an input mode by sound. The key input mode is an input mode by key typing. The code input mode is an input mode by reading a code symbol (a bar code and so on). The image input mode is an input mode by image recognition. When the switching menu button CM accepts the touch operation by the customer for displaying the menu of the input mode, the shopping list creation support processor 211 controls the display operation of the display 23, so as to display the menu of the input mode, using the display 23. The display 23 displays a plurality of the above-described input modes as the menu of the input mode. In the state where the menu of the input mode is displayed, the customer can select any one input mode out of a plurality of the above-described input modes. The switching menu button CM accepts the touch operation by the customer for selecting an input mode, to accept the selection of the input mode by the customer. When the switching menu button CM accepts the selection of an input mode by the customer, the shopping list creation support processor 211 judges the input mode selected by the customer. When the shopping list creation support processor 211 judges the input mode selected by the customer, the processing of the shopping support system 1 proceeds to a processing step S12 of the customer terminal 2.

In the step S12, the shopping list creation support processor 211 of the customer terminal 2 accepts input of a candidate commodity by the customer, with a method according to the input mode selected by the customer. When the shopping list creation support processor 211 accepts the input of the candidate commodity by the customer, using the display and so on, the processing of the shopping support system 1 proceeds to a processing step S13 of the customer terminal 2. In the step S13, the shopping list creation support processor 211 displays the candidate commodity inputted by the customer in the shopping list screen G1, using the display 23. For example, the shopping list creation support processor 211 controls the display operation of the display 23, so as to display the candidate commodity inputted by the customer in the shopping list screen G1, using the display 23. The display 23 is controlled by the shopping list creation support processor 211, to display the candidate commodity as the shopping list in the shopping list screen G1. The above-described inputted candidate commodity may be of a concrete name, or may be of a common name.

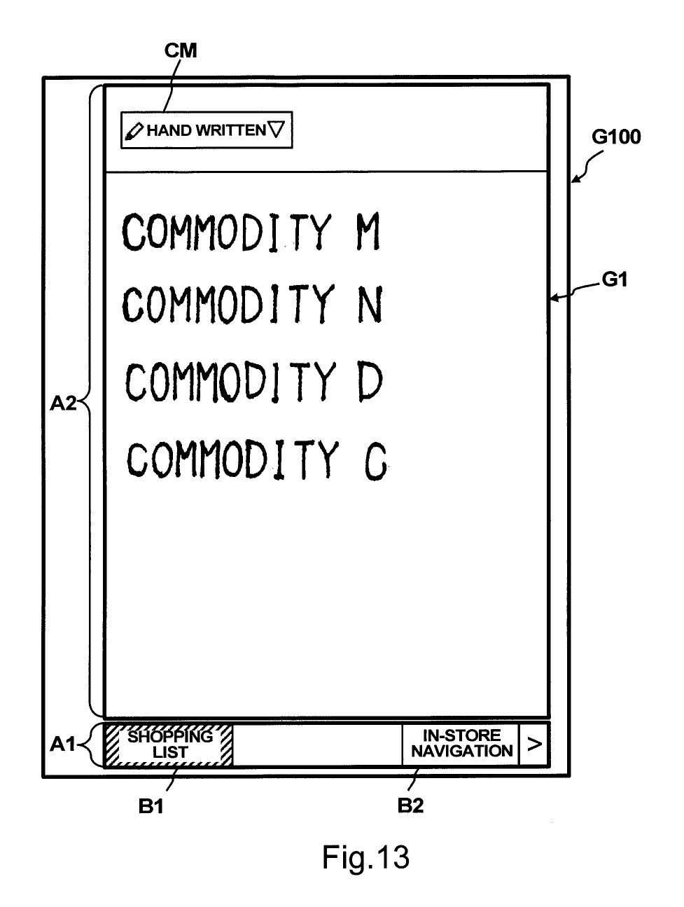

For example, when the switching menu button CM accepts the selection of the handwritten character input mode, as the above-described input mode, the shopping list creation support processor 211 judges that the input mode selected by the customer is the handwritten character input mode. The shopping list creation support processor 211 controls the display operation of the display 23, so as to accept the handwritten characters of the customer for the shopping list screen G1 using the display 23. The display 23 is controlled by the shopping list creation support processor 211, to accept the handwritten characters of the customer in the shopping list screen G1, and output input data corresponding to the handwritten characters. The shopping list creation support processor 211 recognizes a character string expressing a commodity name (a common name, for example) of the candidate commodity, from the input data of the handwritten characters outputted by the display 23, using a publicly-known handwritten character recognition technology. FIG. 13 is a diagram showing the shopping list screen G1 included in the shopping list creation screen G100, in which handwritten characters corresponding to character strings “commodity M”, “commodity N”, “commodity D”, and “commodity C” are inputted, as commodity names of the common names of the candidate commodities, by the customer, for example. As shown in FIG. 13, when the handwritten characters are inputted in the shopping list screen G1 by the customer, the shopping list creation support processor 211 recognizes the character strings “commodity M”, “commodity C” and so on, as the common names of the commodity names of the candidate commodities, from the input data corresponding to the handwritten characters outputted by the display 23. The shopping list creation support processor 211 recognizes the commodity name of the candidate commodity, to judge the candidate commodity inputted by the customer. The display 23 may hold the display of the handwritten characters in the shopping list screen G1, after the recognition of the above-described handwritten characters. Furthermore, the display 23 may re-display the handwritten characters shown in FIG. 13, into the character string after the recognition of the above-described handwritten characters with a prescribed typeface.

For example, when the switching menu button CM accepts the selection of the sound input mode, as the above-described input mode, the shopping list creation support processor 211 judges that the input mode selected by the customer is the sound input mode. The shopping list creation support processor 211 controls the sound input operation of the sound input unit 25, so as to accept the sound of the customer, using the sound input unit 25. The sound input unit 25 is controlled by the shopping list creation support processor 211, to accept the sound of the customer, and output input data corresponding to the sound. The shopping list creation support processor 211 recognizes a character string expressing a commodity name (common name, for example) of the candidate commodity, from the above-described input data outputted by the sound input unit 25, using a publicly-known sound recognition technology. The shopping list creation support processor 211 recognizes the character string expressing the commodity name, to judge the candidate commodity inputted by the customer. For example, when the switching menu button CM accepts the selection of the key input mode, as the above-described input mode, the shopping list creation support processor 211 judges that the input mode selected by the customer is the key input mode. The shopping list creation support processor 211 controls the key input operation of the operation panel 22, so as to accept the key input of the customer, using the operation panel 22. The operation panel 22 is controlled by the shopping list creation support processor 211, to accept the key input and output input data corresponding to the key input. The shopping list creation support processor 211 recognizes a character string expressing a commodity name (common name, for example) of the candidate commodity, from the above-described input data outputted by the operation panel 22. The shopping list creation support processor 211 recognizes the character string expressing the commodity name, to judge the candidate commodity inputted by the customer.

For example, when the switching menu button CM accepts the selection of the code input mode, as the above-described input mode, the shopping list creation support processor 211 judges that the input mode selected by the customer is the code input mode. The shopping list creation support processor 211 controls the imaging operation of the imaging unit 24, so as to accept the code input of a customer, using the imaging unit 24. The imaging unit 24 is controlled by the shopping list creation support processor 211, to image the code symbol, and output input data corresponding to the code symbol. The shopping list creation support processor 211 decodes the input data corresponding to the above-described code symbol outputted by the imaging unit 24, using a publicly-known reading technology. The shopping list creation support processor 211 recognizes the character string (commodity ID) acquired by decoding, as a character string expressing a commodity name of the candidate commodity.

The shopping list creation support processor 211 recognizes the character string expressing the commodity name, to judge the candidate commodity inputted by the customer. When the commodity name can be identified from the above-described commodity ID, the shopping list creation support processor 211 judges the commodity name corresponding to the commodity ID, as the candidate commodity.

For example, when the switching menu button CM accepts the selection of the image input mode, as the above-described input mode, the shopping list creation support processor 211 judges that the input mode selected by the customer is the image input mode. The shopping list creation support processor 211 controls the imaging operation of the imaging unit 24, so as to input an image of a candidate commodity, using the imaging unit 24. The imaging unit 24 is controlled by the shopping list creation support processor 211, to image the image of the candidate commodity, and output input data corresponding to the image of the candidate commodity. The shopping list creation support processor 211 recognizes a commodity name of the commodity name, from the above-described input data outputted from the above-described imaging unit 24, using a publicly-known object recognition technology. The shopping list creation support processor 211 recognizes the commodity name of the candidate commodity, to judge the candidate commodity inputted by the customer.

As described above, when the input mode selected by the customer is the handwritten character input mode, an input accepting unit to accept the input of the candidate commodity by the customer is the display 23. When the input mode selected by the customer is the sound input mode, an input accepting unit to accept the input of the candidate commodity by the customer is the sound input unit 25. When the input mode selected by the customer is the key input mode, an input accepting unit to accept the input of the candidate commodity by the customer is the operation panel 22. When the input mode selected by the customer is the code input mode or the image input mode, an input accepting unit to accept the input of the candidate commodity by the customer is the imaging unit 24. Accordingly, in the above-described step S12, the input accepting unit corresponding to the above-described input mode accepts the above-described candidate commodity. The shopping list creation support processor 211 judges the candidate commodity which has been accepted by the input accepting unit. In the above-described step S13, the display 23 displays the commodity name (common name) of the candidate commodity which has been judged by the shopping list creation support processor 211, in the shopping list screen G1. When the shopping list creation support processor 211 displays the candidate commodity in the shopping list screen G1, using the display 23, the processing of the shopping support system 1 proceeds to a processing step S14 of the customer terminal 2. In the step S14, the shopping list creation support processor 211 generates purchase schedule information including the commodity name, and the commodity ID of the above accepted candidate commodity. The shopping list creation support processor 211 transmits the above-described purchase schedule information, along with the customer ID, to the center server 3, using the communication I/F 26. For example, the shopping list creation support processor 211 controls the communication operation of the communication I/F 26, so as to transmit the above-described purchase schedule information, along with the customer ID, to the center server 3, using the communication I/F 26. The communication I/F 26 is controlled by the shopping list creation support processor 211, to transmit the purchase schedule information, along with the customer ID, to the center server 3. The shopping list creation support processor 211 may transmit the purchase schedule information to the center server 3, using the communication I/F 26, each time the above-described candidate commodity is accepted by the above-described input accepting unit, or may transmit a plurality of candidate commodities to the center server 3 all at once, in accordance with the acceptance of a prescribed operation and so on by a customer.

When the shopping list creation support processor 211 transmits the purchase schedule information, along with the customer ID, to the center server 3, using the communication I/F 26, the processing of the shopping support system 1 proceeds to a processing step S15 of the center server 3. In the step S15, the mediation processing processor 311 of the center server 3 receives the customer ID and the purchase schedule information from the customer terminal 2, using the communication I/F 34. For example, the mediation processing processor 311 controls the communication operation of the communication I/F 34, so as to receive the customer ID and the purchase schedule information from the customer terminal 2, using the communication I/F 34. The communication I/F 34 is controlled by the mediation processing processor 311, to receive the customer ID and the purchase schedule information from the customer terminal 2. In addition, the mediation processing processor 311 stores the customer ID and the purchase schedule information, using the storage unit 35. For example, the mediation processing processor 311 controls the storage operation of the storage unit 35, so as to store the customer ID and the purchase schedule information, using the storage unit 35. The shipping list management table T1 of the storage unit 35 is controlled by the mediation processing processor 311, to store the above received customer ID and purchase schedule information. When the mediation processing processor 311 stores the customer ID and the purchase schedule information, using the shopping list management table T1, the processing of the shopping support system 1 proceeds to a processing step 16 of the center server 3. In the step S16, the mediation processing processor 311 of the center server 3 transmits the above received customer ID and purchase schedule information, to the store server 4, using the communication I/F 34. For example, the mediation processing processor 311 controls the communication operation of the communication I/F 34, so as to transmit the above received customer ID and purchase schedule information, to the store server 4, using the communication I/F 34. The communication I/F 34 is controlled by the mediation processing processor 311, to transmit the customer ID and the purchase schedule information to the store server 4.

In the above-described step S16, a selection method of the store server 4 that becomes a transmission destination of the customer ID and the purchase schedule information is not limited. For example, the mediation processing processor 311 selects the store server 4 of a store to sell the candidate commodity, as the above-described transmission destination. The communication I/F 34 transmits the customer ID and the purchase schedule information to the store server 4 of this selected store. For example, the mediation processing processor 311 selects the whole store servers 4 connected to the center server 3, as the above-described transmission destinations. The communication I/F 34 transmits the customer ID and the purchase schedule information to the store servers of the selected stores. In addition, the mediation processing processor 311 selects the store server 4 that becomes the above-described transmission destination, based on the purchase history information stored in the first purchase history management table T2, for example. Specifically, the mediation processing processor 311 extracts the purchase history information which has been stored corresponding to the customer ID transmitted from the customer terminal 2, from the first purchase history management table T2. The mediation processing processor 311 selects the store server 4 corresponding to the store ID included in the extracted purchase history information, as the above-described transmission destination. For example, the mediation processing processor 311 selects the store servers 4 corresponding to the whole store IDs included in the above extracted purchase history information, as the above-described transmission destinations. In addition, the mediation processing processor 311 selects the store server 4 corresponding to the store ID satisfying a specific condition, out of the store IDs (stores) included in the above extracted purchase history information, as the above-described transmission destination, for example. The store ID (store) satisfying a specific condition is a store ID (store) of a store in which the number of the above extracted purchase history information is not less than a prescribed value, for example. Furthermore, the store ID satisfying a specific condition is a store ID of a store in which the candidate commodity included in the above-described purchase schedule information has been purchased by the customer corresponding to the above-described customer ID, for example. The communication I/F 34 transmits the customer ID and the purchase schedule information to the store server 4 of the above-described selected store.

When the mediation processing processor 311 transmits the above-described customer ID and purchase schedule information to the store server 4, using the communication I/F 34, the processing of the shopping support system 1 proceeds to a processing step S17 of the store server 4. In the step S17, the commodity extraction processor 411 of the store server 4 receives the customer ID and the purchase schedule information from the center server 3, using the communication I/F 44. For example, the commodity extraction processor 411 controls the communication operation of the communication I/F 44, so as to receive the customer ID and the purchase schedule information from the center server 3, using the communication I/F 44. The communication I/F 44 is controlled by the commodity extraction processor 411, to receive the customer ID and the purchase schedule information from the center server 3. The commodity extraction processor 411 extracts the commodity information which has been stored corresponding to the candidate commodity included in the purchase schedule information received by the communication I/F 44, from the commodity management table T3.

In the above-described step S17, when the commodity name of the above-described candidate commodity is expressed by a concrete name, the commodity extraction processor 411 extracts the commodity information which has been stored corresponding to the relevant concrete name, from the commodity management table T3. For example, when the commodity name of the above-described candidate commodity is expressed by a common name, the commodity extraction processor 411 extracts the commodity information which has been stored corresponding to the relevant common name, from the commodity management table T3. For example, when the above-described candidate commodity is expressed by a commodity ID, the commodity extraction processor 411 extracts the commodity information which has been stored corresponding to the relevant commodity ID, from the commodity management table T3.

When the commodity extraction processor 411 extracts the commodity information which has been stored corresponding to the candidate commodity included in the purchase schedule information, from the commodity management table T3, the processing of the shopping support system 1 proceeds to a processing step S18 of the store server 4. In the step S18, the privilege imparting processor 412 of the store server 4 generates (issues) an electronic coupon instructing to impart privilege such as a discount and point imparting, to the candidate commodity included in the purchase schedule information which the commodity extraction processor 411 has received.

In the above-described step S18, the candidate commodity that becomes a privilege imparting object is not limited. For example, when it is previously determined that a privilege is imparted to a specific commodity, the privilege imparting processor 412 generates an electronic coupon to the candidate commodity corresponding to the above-described specific commodity, out of the candidate commodities included in the purchase schedule information which the commodity extraction processor 411 has received.

In addition, the privilege imparting processor 412 dynamically determines a commodity that becomes a privilege imparting object and a privilege content, for example. Specifically, the privilege imparting processor 412 refers to the commodity information or the purchase history information stored corresponding to the above-described customer ID which has been received from the center server 3, from the purchase commodity management table T4 or the second purchase history management table T5. The privilege imparting processor 412 determines a commodity that becomes a privilege imparting object and a privilege content, based on a purchase rate described later obtained from the referred commodity information or purchase history information, and the purchase result. The privilege imparting object is not limited to a commodity unit, but may be the whole commodities, or may be a store visitor to the own store. In addition, the privilege imparting processor 412 may determine an expiration time, and so on to the above-described electronic coupon.

When the privilege imparting processor 412 generates an electric coupon to each of the candidate commodities included in the purchase schedule information which has been accepted by the commodity extraction processor 411, the processing of the shopping support system 1 proceeds to a step S19 of the store server 4. In the step S19, the additional information provision processor 4 of the store server 4 generates additional information which is added to each of the candidate commodities included in the purchase schedule information which has been accepted by the commodity extraction processor 411. The above-described additional information includes the commodity information of each of the candidate commodities extracted by the commodity extraction processor 411. In addition, the above-described additional information includes the electronic coupon generated (issued) by the privilege imparting processor 412. Furthermore, the above-described additional information includes the store ID of the own store. The additional information provision processor 413 transmits the above-described additional information to the center server 3, using the communication I/F 44. For example, the additional information provision processor 413 controls the communication operation of the communication I/F 44, so as to transmit the above-described additional information to the center server 3, using the communication I/F 44. The communication I/F 44 is controlled by the additional information provision processor 413, to transmit the above-described additional information, along with the customer ID received from the center server 3, to the center server 3.

In the above-described step S19, the information to be included in the above-described additional information is not limited to the above, but may include other information. For example, the additional information may include advertisement information for advertising the own store and a specific commodity and so on. The advertisement information may be previously prepared, or may be dynamically generated by the additional information provision processor 413 and so on, based on the commodity information and so on extracted by the commodity extraction processor 411. Furthermore, as a reply processing to the transmission of the customer ID and the purchase scheduled information from the center server 3 in the above-described step S16, in the above-described step S19, the additional information provision processor 413 of the store server 4 generates the above-described additional information as described above, and transmits the above-described additional information to the center server 3, using the communication I/F 44. However, the reply processing to the transmission of the customer ID and the purchase scheduled information from the center server 3 in the above-described step S16 is not limited to the above-described processing. For example, an employee of a store may manually instruct the generation of the additional information to the store server 4, based on the purchase schedule information transmitted from the center server 3, and may instruct a reply of the additional information. In this case, an employee of the store manually perform the instruction to generate (issue) an electronic coupon instructing to impart the privilege such as a discount to the commodity in which the purchase schedule number of the candidate commodities included in the purchase schedule information is large, to the store server 4, to achieve promotion of coming of customers to the own store.

When the additional information provision processor 413 transmits the above-described additional information, along with the customer ID, to the center server 3, using the communication I/F 44 of the store server 4, the processing of the shopping support system 1 proceeds to a processing step S20 of the center server 3. In the step S20, the mediation processing processor 311 of the center server 3 receives the customer ID and the additional information from the store server 4, using the communication I/F 34. For example, the mediation processing processor 311 controls the communication operation of the communication I/F 34, so as to receive the customer ID and the additional information from the store server 4, using the communication I/F 34. The communication I/F 34 is controlled by the mediation processing processor 311, to receive the customer ID and the above-described additional information from the store server 4. In addition, the mediation processing processor 311 controls the storage operation of the storage unit 35, so as to store the above-described received additional information, using the storage unit 35. The shopping list management table T1 of the storage unit 35 is controlled by the mediation processing processor 311, to store the above-described additional information corresponding to the customer ID received by the communication I/F 34.

When the mediation processor 311 stores the above-described additional information, using the storage unit 35, the processing of the shopping support system 1 proceeds to a processing step S21 of the center server 3. In the step S21, the comment adding processor 312 of the center server 3 adds the comment information stored in the first purchase history management table T2 of the storage unit 35, to the commodity information of the candidate commodity included in the additional information accepted by the above-described mediation processor 311. Specifically, the comment adding processor 312 refers to the purchase history information stored in the first purchase history management table T2, corresponding to the customer ID accepted by the mediation processor 311. Furthermore, the comment adding processor 312 refers to the comment information stored in the first purchase history management table T2, corresponding to the commodity ID included in this referred purchase information. The comment adding processor 312 reads the comment information corresponding to the candidate information from the first purchase history management table T2, out of the referred comment information. In addition, the comment adding processor 312 adds the read comment information to the commodity information of the candidate information included in the above-described additional information.

When the comment adding processor 312 adds the above-described comment information to the commodity information of the candidate commodity included in the additional information, the processing of the shopping support system 1 proceeds to a processing step S22 of the center server 3. In the step S22, the regular item adding processor 313 of the center server 3 adds regular item information expressing a regular item, to the commodity information of the candidate commodity included in the above-described additional information. The regular item adding processor 313 refers to the purchase history information stored in the first purchase history management table T2, corresponding to the customer ID accepted from the store server 4 by the above-described mediation processor 311. Furthermore, the regular item adding processor 313 specifies a commodity in which the number of purchase histories is not less than a prescribed value, for each purchase commodity group in the same category (common name, for example) as the above-described candidate commodity, as a regular item, out of the purchase commodities included in this referred purchase history information. The regular item adding processor 313 may specify a commodity having the largest number of purchase histories as a regular item. The regular item adding processor 312 adds the regular item information indicating the above-described specified regular item, to the commodity information of the relevant candidate commodity included in the above-described additional information.

When the regular item adding processor 313 adds the above-described regular item information to the commodity information of the candidate commodity included in the above-described additional information, the processing of the shopping support system 1 proceeds to a processing step S23 of the center server 3. In the step S23, the mediation processing processor 311 of the center server 3 transmits the additional information in which the comment information and the regular item information are added to the commodity information of the candidate commodity, to the customer terminal 2, using the communication I/F 34. For example, the mediation processing processor 311 controls the communication operation of the communication I/F 34, so as to transmit the above-described adding information to the customer terminal 2, using the communication I/F 34. The communication I/F 34 is controlled by the mediation processing processor 311, to transmit the additional information in which the comment information and the regular item information are added to the commodity information of the candidate commodity, to the customer terminal 2 of the customer ID (refer to the step S20) received from the store server 4.

When the mediation processor 311 transmits the above-described additional information using the communication I/F 34, the processing of the shopping support system 1 proceeds to a processing step S24 of the customer terminal 2. In the step S24, the shopping list creation support processor 211 of the customer terminal 2 receives the above-described additional information in which the above-described comment information and the above-decried regular item information are added to the commodity information of the candidate commodity, from the center server 3, using the communication I/F 26. For example, the shopping list creation support processor 211 controls the communication operation of the communication I/F 26, so as to receive the above-described additional information from the center server 3, using the communication I/F 26. The communication I/F 26 is controlled by the shopping list creation support processor 211, to receive the above-described additional information from the center server 3. In addition, the shopping list creation support processor 211 updates the display content of the shopping list screen G1, using the display 23. For example, the shopping list creation support processor 211 controls the display operation of the display 23, so as to update the display content of the shopping list screen G1, using the display 23. The display 23 is controlled by the shopping list creation support processor 211, to update the display content of the candidate commodity in the shopping list screen G1, based on the information of the electronic coupon and the regular item information included in the above-described additional information which has been received from the center server 3.

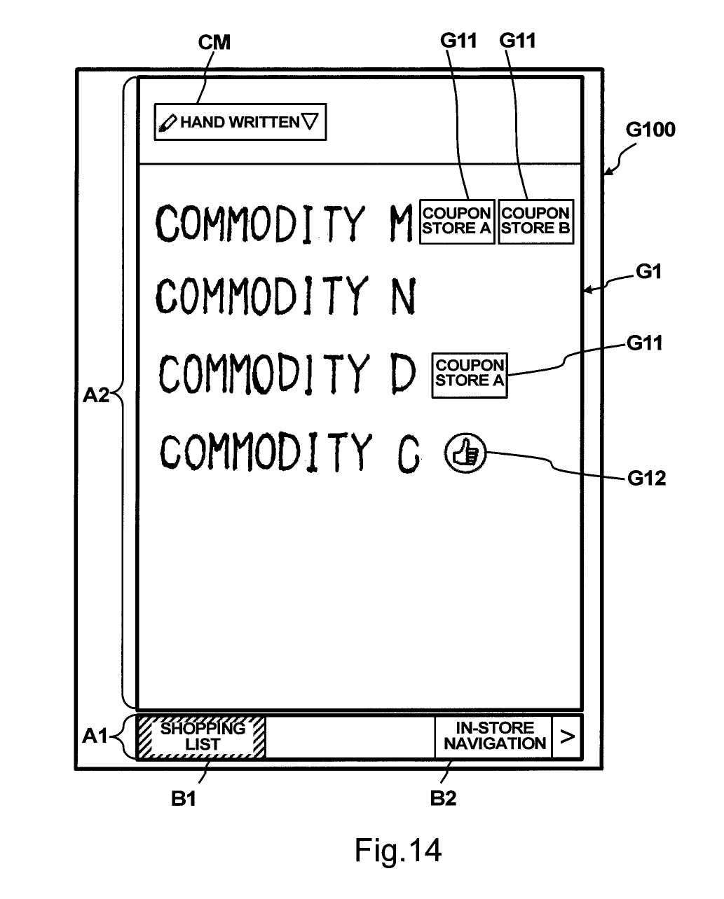

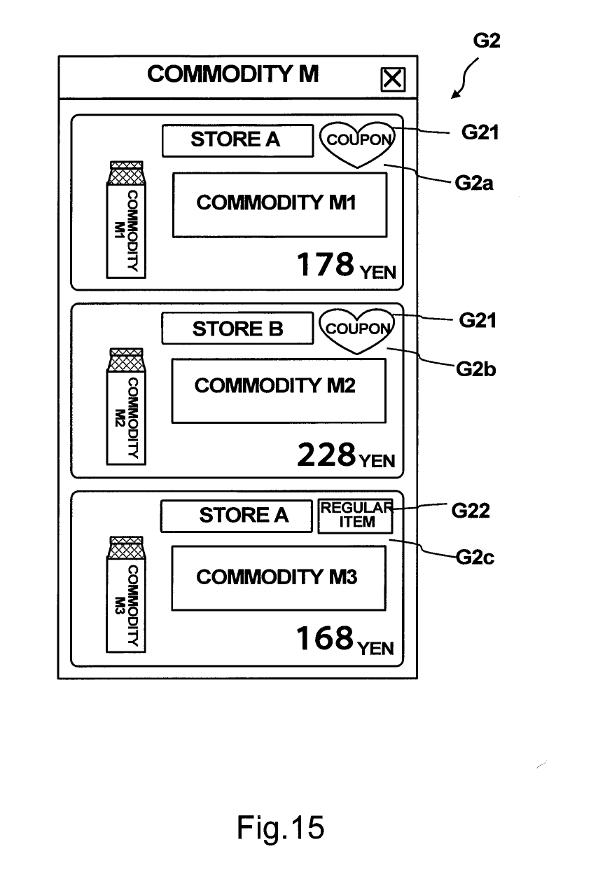

FIG. 14 is a diagram showing an example of the shopping list screen G1 after update. As shown in FIG. 14, the display unit 23 adds a coupon icon G11 to the shopping list screen G1, to display the shopping list screen G1 after update. A coupon icon G11 is an identifier indicating that an electronic coupon has been provided to the relevant candidate commodity. The display unit 23 displays the coupon icon G11, corresponding to the relevant candidate commodity. In the coupon icon G11, a character string (“coupon”, for example) indicating that an electronic coupon is provided to the relevant candidate commodity, and a character string (“store A”, for example) showing a name of a store providing the electronic coupon are displayed. For example, in FIG. 14, the candidate commodity “commodity M” shows that electronic coupons are provided from a store A and a store B. In addition, the candidate commodity “commodity D” shows that an electronic coupon is provided from the store A. In other words, the shopping list screen G1 after update shows that regarding the candidate commodities “commodity M” and “commodity D”, commodities to which an electronic coupon has been provided are present in the store A. In addition, the shopping list screen G1 after update shows that regarding the candidate commodity “commodity M”, a commodity to which an electronic coupon has been provided is present in the store B. When the shopping list screen G1 accepts selection of the candidate commodity “commodity M” by a touch operation by a customer, for example, the shopping list creation support processor 211 controls the display operation of the display unit 23, so as to display a detailed screen G2 of the candidate commodity “commodity M”, using the display unit 23. The display unit 23 is controlled by the shopping list creation support processor 211, to display the detailed screen G2 shown in FIG. 15, in the second area A2 of the shopping list creation screen G100.

FIG. 15 is a diagram showing an example of the detailed screen G2 of the candidate commodity “commodity M”. As shown in FIG. 15, the detailed screen G2 has a title display column (an uppermost portion of FIG. 15, for example) and a plurality of commodity display columns G2a, G2b, G2c. The display unit 23 displays a character string (“commodity M”, for example) indicating a commodity name (common name, for example) of the candidate commodity which has accepted the above-described selection, in the above-described title display column. The display unit 23 displays the commodity information provided from the respective stores (store servers 4), regarding the candidate commodity which has accepted the above-described selection, in the respective commodity display columns G2a, G2b, G2c. The display unit 23 displays the commodity display columns G2a, G2b, G2c in a line, so that the commodity information provided from the respective stores can be compared easily by the customer. The above-described commodity information displayed in each of the commodity display columns G2a, G2b, G2c includes a store name, a commodity name, a unit price of the commodity, regular item information and information of an electronic coupon. The display unit 23 displays a character string (“store A”, for example) indicating a store name in the commodity display column. The display unit 23 displays a character string (“commodity M1”, for example) indicating a concrete name of the commodity in the commodity display column. The display unit 23 displays numerals indicating a unit price of the commodity in the commodity display column. The display unit 23 displays a regular item icon G22 as the regular item information in the commodity display column. The display unit 23 displays a coupon icon G21 as the information of an electronic coupon in the commodity display column. In addition, the display unit 23 displays an image of the commodity in the commodity display column. For example, in the commodity display column G2a shown in FIG. 15, the information of the commodity name “commodity M1” provided from the store A, and the coupon icon G21 are displayed. In the commodity display column G2b, the information of the commodity name (concrete name) “commodity M2” provided from the store B, and the coupon icon G21 are displayed. The unit prices displayed in the commodity display column G2a and the commodity display column G2b respectively mean unit prices after discount with the electronic coupons being applied. The coupon icon G21 is an identifier indicating that the relevant commodity is a commodity added an the electronic coupon. In the coupon icon G21, a character string “coupon” is displayed, for example.

In addition, in the commodity display column G2c, regarding the candidate commodity which has accepted the above-described selection, the commodity information of the commodity name (concrete name) “commodity M3” added with the regular item information and the regular item icon G22. The regular item icon G22 is an identifier indicating that the relevant commodity is a commodity added with regular item information. In the regular item icon G32, a character string “regular item” is displayed, for example. When other commodity information is present, regarding to the candidate commodity which has accepted the above-described selection, the display unit 23 adds the same commodity display column as the commodity display column G2a—the commodity display column G2c, and displays the information therein. In addition, when of a plurality of commodity information are present, the display unit 23 preferentially displays the commodity added with the electronic coupon and regular item information as shown in FIG. 15.

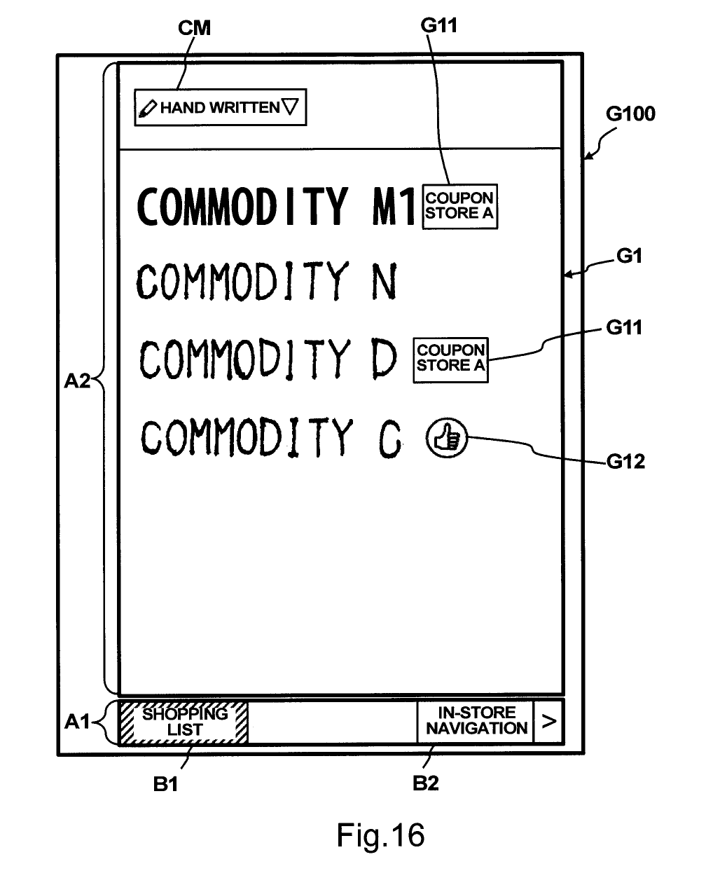

In FIG. 15, when the detailed screen G2 accepts selection of a commodity by a touch operation of the customer terminal 2 by a customer, for example, the shopping list creation support processor 211 controls the display operation of the display 23, so as to display the further updated shopping list screen G1, using the display 23. The display 23 is controlled by the shopping list creation support processor 211, to erase the detailed screen G2, and display the further updated shopping list screen G1. Specifically, the display unit 23 displays the relevant candidate commodity in the shopping list screen G1, by switching it to the commodity name (concrete name) of the commodity selected in the detailed screen G2, as shown in FIG. 16. FIG. 16 is a diagram showing the shopping list screen G1, when the commodity in which the detailed screen G2 has accepted the selection is the commodity name “commodity M1”. For example, the display unit 23 displays the handwritten character string “commodity M” indicating the commodity name of the common name in the shopping list screen G1 shown in FIG. 14, by switching it to a character string “commodity M1” of a prescribed typeface indicating the commodity name of the concrete name, as shown in FIG. 16.

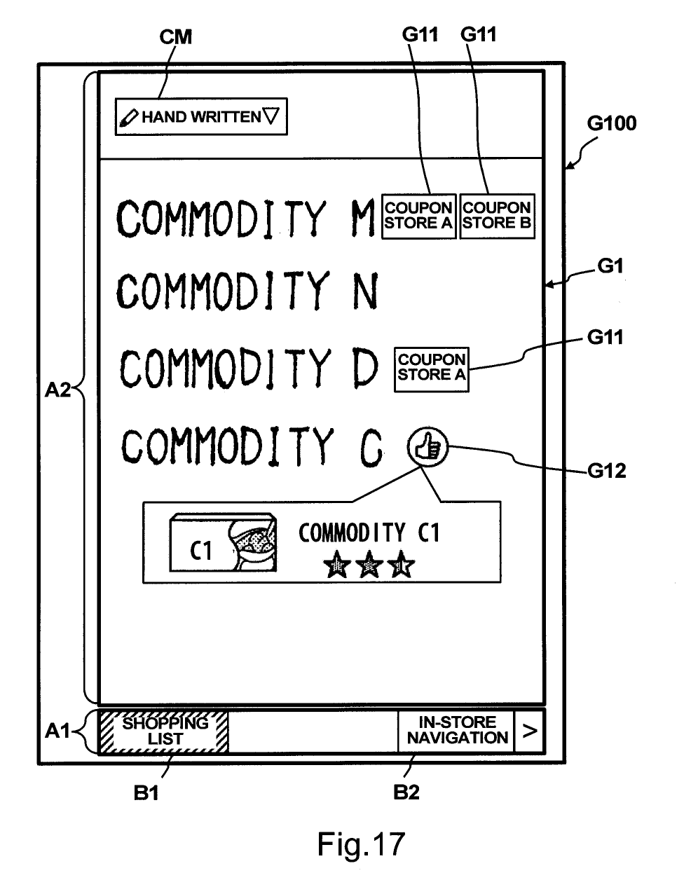

In addition, the display unit 23 displays a comment icon G12, corresponding to the commodity name of the candidate commodity, in the shopping list screen G1 of FIG. 14 (FIG. 16). The comment icon G12 is an identifier indicating that a commodity added with the above-described comment information is present. FIG. 14 (FIG. 16) shows that a commodity added with the comment information is present, regarding the candidate commodity “commodity C”. For example, when the shopping list screen G1 accepts selection of the comment icon G12 by a touch operation of a customer, the shopping list creation support processor 211 controls the display operation of the display 23, so as to display the commodity information and the comment information, using the display 23, regarding the candidate commodity to which the comment icon G12 is made to correspond. FIG. 17 is a diagram showing the shopping list screen G1, when the shopping list screen G1 has accepted the selection of the comment icon G12 which is made to correspond to the candidate commodity “commodity C”. The display 23 is controlled by the shopping list creation support processor 211, to display a character string of “commodity C1” indicating a concrete name and an image of the commodity C1, as the commodity information, regarding the candidate commodity “commodity C”, as shown in FIG. 17. Furthermore, the display unit 23 displays stars indicating the evaluation for a commodity C1 by a plurality of customers, as the comment information, as shown in FIG. 17.

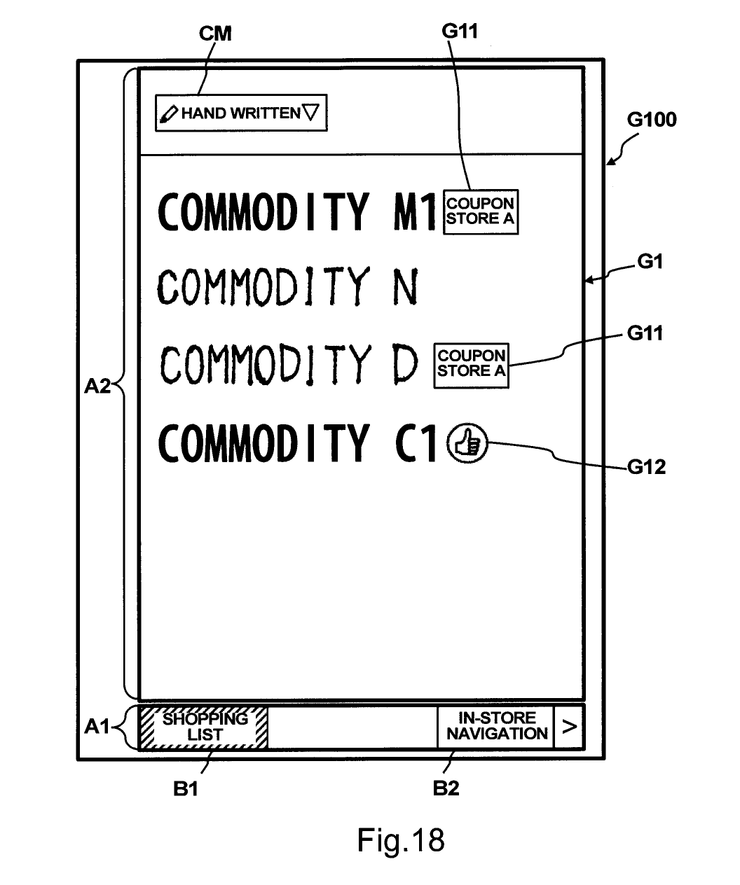

In FIG. 17, when the shopping list screen G1 accepts selection of “commodity C1” by a touch operation of a customer, the shopping list creation support processor 211 controls the display operation of the display 23, so as to display the further updated shopping list screen G1, using the display 23. FIG. 18 is a diagram showing the shopping list screen G1 when the shopping list screen G1 has accepted the selection of “commodity C1”. The display 23 is controlled by the shopping list creation support processor 211, to display the handwritten character string of “commodity C” indicating the commodity name of the common name in the shopping list screen G1 shown in FIG. 16, by switching it to a character string of a prescribed typeface of “commodity C1” indicating the commodity name of the concrete name as shown in FIG. 18.

As described above, a customer who is an operator of the customer terminal 2 can select and display a concrete name of a desired commodity, out of the concrete name of the commodity included in the additional information, for the candidate commodity inputted in the customer terminal 2. By this means, the customer can select the candidate commodity, while confirming the information of the commodity and the electronic coupon provided from each store. Accordingly, the shopping support system 1 can achieve sales promotion of the commodity, and can improve convenience pertaining to commodity selection. In the above-described embodiment, it is not essential that the shopping list screen G1 of the customer terminal 2 displays the concrete names of the whole candidate commodities. A candidate commodity expressed by a common name may be present, out of a plurality of candidate commodities which the shopping list screen G1 displays.

Furthermore, since a store can grasp what each of customers desires, the shopping support system 1 can issue only an electronic coupon pertaining to the commodity (candidate commodity) which the customer desires. By this means, a store side can effectively approach each of customers, without issuing a useless electronic coupon. Furthermore, since the customer does not receive a useless electronic coupon, the customer can effectively select the candidate commodity.

In FIG. 11, when the display unit 23 displays the updated shopping list screen G1 (refer to FIG. 18), the processing of the shopping support system 1 proceed to a processing step S25 of the customer terminal 2. In the step S25, the shopping list creation support processor 211 of the customer terminal 2 transmits the display screen information of the shopping list screen G1, along with the customer ID, to the center server 3, using the communication I/F 26. For example, the shopping list creation support processor 211 controls the communication operation of the communication I/F 26, so as to transmit the display screen information of the shopping list screen G1, along with the customer ID, to the center server 3, using the communication I/F 26. The display screen information includes data set for realizing or reproducing the display state of the shopping list displayed (inputted) in the shopping list screen G1. The communication I/F 26 is controlled by the shopping list creation support processor 211, to transmit the display screen information along with the customer ID, to the center server 3.

When the communication I/F 26 of the customer terminal 2 transmits the display screen information to the center server 3, the processing of the shopping support system 1 proceeds to a processing step S26 of the center server 3. In the step S26, the mediation processing processor 311 of the center server 3 receives the customer ID and the display screen information from the customer terminal 2, using the communication I/F 34. For example, the mediation processing processor 311 controls the communication operation of the communication I/F 34, so as to receive the customer ID and the display screen information from the customer terminal 2, using the communication I/F 34. The communication I/F 34 is controlled by the mediation processing processor 311, to receive the customer ID and the display screen information. The mediation processing processor 311 controls the storage operation of the storage unit 35, so as to store the above-described received display screen information, using the storage unit 35. The shopping list management table T1 of the storage unit 35 is controlled by the mediation processing processor 311, to store the above-described display screen information corresponding to the above-described received customer ID.

After the shopping list management table T1 stores the display screen information, the shopping list creation support processor 211 and the mediation processing processor 311 cooperate with each other, and thereby the customer terminal 2 and the center server 3 execute synchronous processing of the purchase schedule information, the additional information and the display screen information which are stored in them, respectively. Specifically, when in one device of the customer terminal 2 and the center sever 3, any of the purchase schedule information, the additional information and the display screen information is updated, the other device updates any of the purchase schedule information, the additional information and the display screen information so that the updated content is reflected.

Furthermore, when the communication I/F 34 of the center server 3 receives the notification of the customer ID from the relevant customer terminal 2 at the time of starting the customer terminal 2, the mediation processing processor 311 reads the purchase schedule information, the additional information and the display screen information corresponding to this customer ID, from the shopping list management table T1. The mediation processing processor 311 provides the above read purchase schedule information, additional information and display screen information to the customer terminal 2, using the communication I/F 34. For example, the mediation processing processor 311 controls the communication operation of the communication I/F 34, so as to provide the above read purchase schedule information, additional information and display screen information, using the communication I/F 34. The communication I/F 34 is controlled by the mediation processing processor 311, to transmit the purchase schedule information, the additional information and the display screen information to the customer terminal 2. The shopping list creation support processor 211 of the customer terminal 2 receives the above-described purchase schedule information, additional information and display screen information from the center server 3, using the communication I/F 26. For example, the shopping list creation support processor 211 controls the communication operation of the communication I/F 26, so as to receive the above-described purchase schedule information, additional information and display screen information from the center server 3, using the communication I/F 26. The communication I/F 26 is controlled by the shopping list creation support processor 211, to receive the above-described purchase schedule information, additional information and display screen information from the center server 3. The shopping list creation support processor 211 of the customer terminal 2 compares the above-described respective information (the purchase schedule information, the additional information and the display screen information) received by the communication I/F 26, with the respective information (the purchase schedule information, the additional information and the display screen information) which are locally stored by the storage unit 28. The storage unit 28 updates the storage content to the information whose update date and time is newer, based on the above-described comparison result by the shopping list creation support processor 211.

The customer terminal 2 updates the respective information, as described above, and thereby a customer inputs the same customer ID to an optional customer terminal 2, and can make the optional customer terminal 2 display the shopping list which the relevant customer has created. For example, the customer creates a shopping list on the large customer terminal 2 such as a tablet, and can make a portable and small customer terminal 2 display the shopping list. Accordingly, the shopping support system 1 can improve convenience pertaining to the usage of the shopping list.

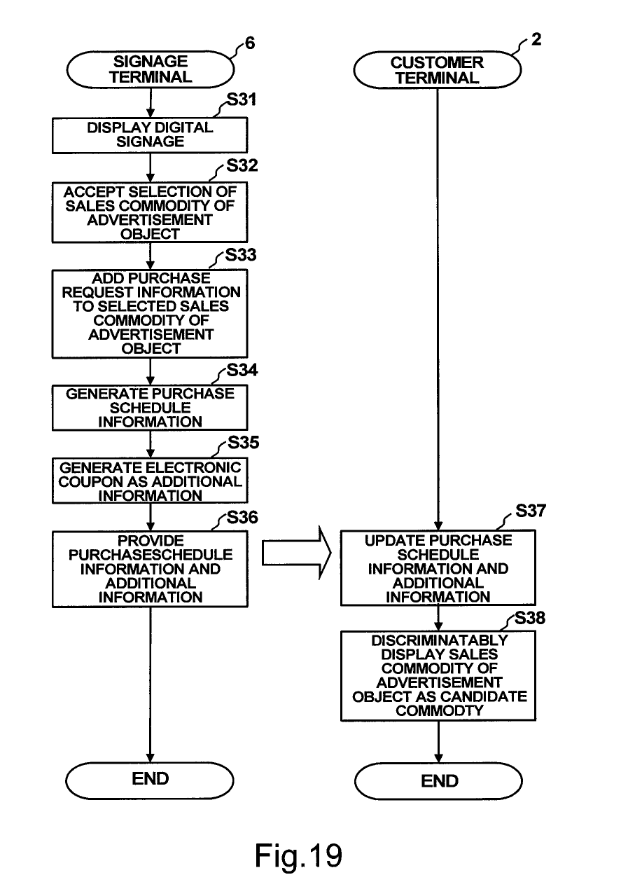

Hereinafter, a second creation support processing pertaining to creation of the shopping list will be described with reference to FIG. 19 to FIG. 21. The second creation support processing adds the commodity which is notified from the signage terminal 6 and so on to the customer terminal 2, to the above-described shopping list, as the candidate commodity.

FIG. 19 is a flow chart showing the second creation support processing by the shopping support system 1. As shown in FIG. 19, in a processing step S31 of the signage terminal 6, the content reproduction processor 611 of the signage terminal reproduces the content data pertaining to the above-described digital signage, to make the display 63 display/output the digital signage. The digital signage is a guide and advertisement information for advertising a specific store and sales commodity and so on, as described above. As described above, the content data include image data and sound data. For example, the content reproduction processor 611 reads the content data from the storage unit 66. The content reproduction processor 611 generates a reproduced image (still picture or moving picture) for advertising a specific store and sales commodity and so on, based on the read content data. The content reproduction processor 611 controls the display operation of the display 63, so as to display the above generated reproduced image, using the display 63. The display 63 is controlled by the content reproduction processor 611, to display the above-described reproduced image as the above-described digital signage. In addition, the content reproduction processor 611 generates a sound so as to advertise a specific store and sales commodity and so on, based on the above read content data. The content reproduction processor 611 controls the sound output operation of the display 63, so as to output the above generated sound from the display 63, using the display 63. The display 63 is controlled by the content reproduction processor 611, to output the above generated sound as the above-described digital signage.

When the display 63 outputs the digital signage, the processing of the shopping support system 1 proceeds to a processing step S32 of the signage terminal 6. In the step S32, the purchase request processor 612 of the signage terminal 6 accepts selection of the sales commodity of the advertisement object by the operation of an unspecified large number of customers, using the operation panel 62. For example, the purchase request processor 612 controls the acceptance operation of the operation panel 62, so as to accept selection of the sales commodity of the advertisement object by an operation of a customer, using the operation panel 62. The operation panel 62 is controlled by the purchase request processor 612, to accept selection by an operation of a customer, regarding sales commodity in the included in the digital signage. When the operation panel 62 accepts the selection of the sales commodity of the advertisement object by an operation of the customer, the processing of the shopping support system proceeds to a processing step S33 of the signage terminal 6. In the step S33, the purchase request processor 612 of the signage terminal 6 reads the content data from the storage unit 66. Furthermore, the purchase request processor 612 extracts the commodity name and so on of the sales commodity of the advertisement object which has accepted the above-described selection, from the content data. The purchase request processor 612 adds the purchase request information to the above read commodity name. In other words, the purchase request processor 612 adds the purchase request information to the commodity name of the sales commodity of the advertisement object which has accepted the above-described selection. The purchase request information is information showing that purchase request is inputted from the signage terminal 6 (external device) to the sales commodity of the above-described advertisement object. When the purchase request processor 612 adds the purchase request information to the commodity name of the sales commodity of the advertisement object which has accepted the above-described selection, the processing of the shopping support system 1 proceeds to a processing step S34 of the signage terminal 6. In the step S34, the purchase request processor 612 of the signage terminal 6 generates purchase schedule information which determines the sales commodity corresponding to the commodity name added with the purchase request information, as the candidate commodity.

When the purchase request processor 612 generates the purchase schedule information, the processing of the shopping support system 1 proceeds to a processing step S35 of the signage terminal 6. In the step S35, when the information to impart privilege such as a discount to the sales commodity (refer to the step S32) which has received the above-described selection is set in the content data, the purchase request processor 612 generates (issues) an electronic coupon to instruct to further impart the above-described privilege, as the additional information. When the purchase request processor 612 generates the electronic coupon as the additional information, the processing of the shopping support system 1 proceeds to a processing step S36 of the signage terminal 6. In the step S36, the purchase request processor 612 of the signage terminal 6 provides the generated purchase schedule information and additional information, and so on to the customer terminal 2.

In the above-described step S36, as a providing method of the purchase schedule information and the additional information and so on from the signage terminal 6 to the customer terminal 2, various methods can be adopted. For example, the signage terminal 6 may provide the purchase schedule information and the additional information to the customer terminal 2, using the near field communication I/F 65. For example, the purchase request processor 612 controls the communication operation of the near field communication I/F 65, so as to provide the purchase schedule information and the additional information to the customer terminal 2, using the near field communication I/F 65. The near field communication I/F 65 is controlled by the purchase request processor 612, to transmit the purchase schedule information and the additional information and so on to the customer terminal 2. The shopping list creation support processor 211 of the customer terminal 2 receives the purchase schedule information and the additional information and so on from the signage terminal 6, using the near field communication I/F 26. The shopping list creation support processor 211 controls the communication operation of the near field communication I/F 26, so as to receive the purchase schedule information and the additional information and so on from the signage terminal 6, using the near field communication I/F 26. The near field communication I/F 26 is controlled by the shopping list creation support processor 211, to receive the purchase schedule information and the additional information and so on from the signage terminal 6. In addition, the signage terminal 6 may make the display 63 display a code symbol indicating the purchase schedule information and the additional information and so on, to provide the customer terminal 2 with the purchase schedule information and the additional information and so on, through the relevant code symbol. In this case, specifically, the purchase request processor 612 controls the display operation of the display 63, so as to provide the customer terminal 2 with the purchase schedule information and the additional information and so on, using the display 63. The display 63 is controlled by the purchase request processor 612, to display the code symbol indicating the purchase schedule information and the additional information. The customer terminal 2 images the code symbol displayed on the display 63 of the signage terminal 6, using the imaging unit 24, to acquire the purchase schedule information and the additional information from the above-described code symbol.

Furthermore, in the above-described step S36, the signage terminal 6 may provide the customer terminal 2 with the purchase schedule information and the additional information, via the center server 3. In this case, the purchase request processor 612 transmits the above generated purchase schedule information and additional information, along with the customer ID, to the center server 3. The above-described customer ID is inputted to the signage terminal 6 via the operation terminal 62 or the near field communication I/F 65. Specifically, the purchase request processor 612 controls the operation accepting operation of the operation panel 62, so as to accept an input of the above-described customer ID, using the operation panel 62. The operation panel 62 is controlled by the purchase request processor 612, to accept the input of the customer ID by an operation of a customer. In addition, the purchase request processor 612 controls the communication operation of the near field communication I/F 65, so as to accept the input of the above-described customer ID, using the near field communication I/F 65. The near field communication I/F 65 is controlled by the purchase request processor 612, to receive the above-described customer ID from the customer terminal 2. The purchase request processor 612 controls the communication operation of the communication I/F 64, so as to transmit the purchase schedule information and the additional information to the center server 3. The communication I/F 64 is controlled by the purchase request processor 612, to transmit the purchase schedule information and the additional information, along with the above-described customer IC, to the center server 3.

The mediation processing server 311 of the center server 3 accepts the customer ID, the purchase schedule information and the additional information from the signage terminal 6. For example, the mediation processing server 311 controls the communication operation of the communication I/F 34, so as to accept the customer ID, the purchase schedule information and the additional information, using the communication I/F 34. The communication I/F 34 is controlled by the mediation processing processor 311, to receive the customer ID, the purchase schedule information and the additional information, from the signage terminal 6. When the communication I/F 34 receives the customer ID, the purchase schedule information and the additional information, the mediation processing processor 311, using the storage unit 35, adds the purchase schedule information and the additional information which have been accepted from the above-described signage terminal 6, to the purchase schedule information and the additional information which have already been stored, corresponding to the above-described customer ID of the shopping list management table T1. For example, the mediation processing processor 311 controls the storage operation of the storage unit 35, so as to add the purchase schedule information and the additional information which have been accepted from the above-described signage terminal 6 to the shopping list management table T1, using the storage unit 35. The first purchase history management table T2 of the storage unit 35 is controlled by the mediation processing processor 311, to add the purchase schedule information and the additional information which have been accepted from the above-described signage terminal 6, to the purchase schedule information and the additional information which have already been stored in the shopping list management table T1, corresponding to the above-described customer ID. After the first purchase history management table T2 stores the purchase schedule information and the additional information which have been accepted from the above-described signage terminal 6, the mediation processing processor 311 and the shopping list creation support processor 211 cooperate with each other, and thereby the center server 3 and the customer terminal 2 execute synchronous processing of the purchase schedule information and the additional information which are stored in them, respectively.

On the other hand, in the above-described step S36, when the signage terminal 6 provides the customer terminal 2 with the purchase schedule information and the additional information, the processing of the shopping support system 1 proceeds to a processing step S37 of the customer terminal 2. In the step S37, the shopping list creation support processor 211 of the customer terminal 2 updates the purchase schedule information and the additional information which have locally been stored by the storage unit 28. For example, the shopping list creation support processor 211 controls the storage operation of the storage unit 28, so as to update the purchase schedule information and the additional information, using the storage unit 28. The storage unit 28 stores the purchase schedule information and the additional information provided from the signage terminal 6, to update the purchase schedule information and the additional information. When the shopping list creation support processor 211 updates the purchase schedule information and the additional information stored in the storage unit 28, the processing step of the shopping support system 1 proceeds to a processing step S38 of the customer terminal 2. In the step S38, the shopping list creation support processor 211 of the customer terminal 2 detects the candidate commodity (refer to the step S34) added with the above-described purchase request information, which is included in the purchase schedule information stored by the storage unit. The shopping list creation support processor 211 displays the above-described detected candidate commodity in the shopping list screen G1 in a discriminatable state. The discriminatable state is a state in which the customer can discriminate that the commodity is the candidate commodity added with the above-described purchase request information. Specifically, the shopping list creation support processor 211 controls the display operation of the display 23, so as to display the above-described detected candidate commodity, using the display 23. The display 23 is controlled by the shopping list creation support processor 211, to display the above-described detected candidate commodity.

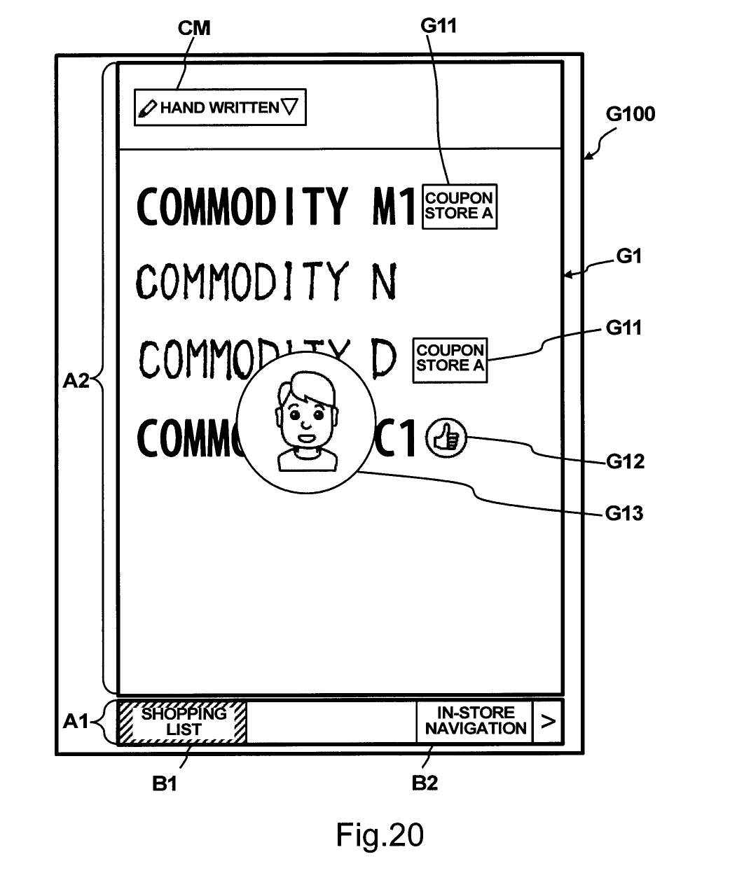

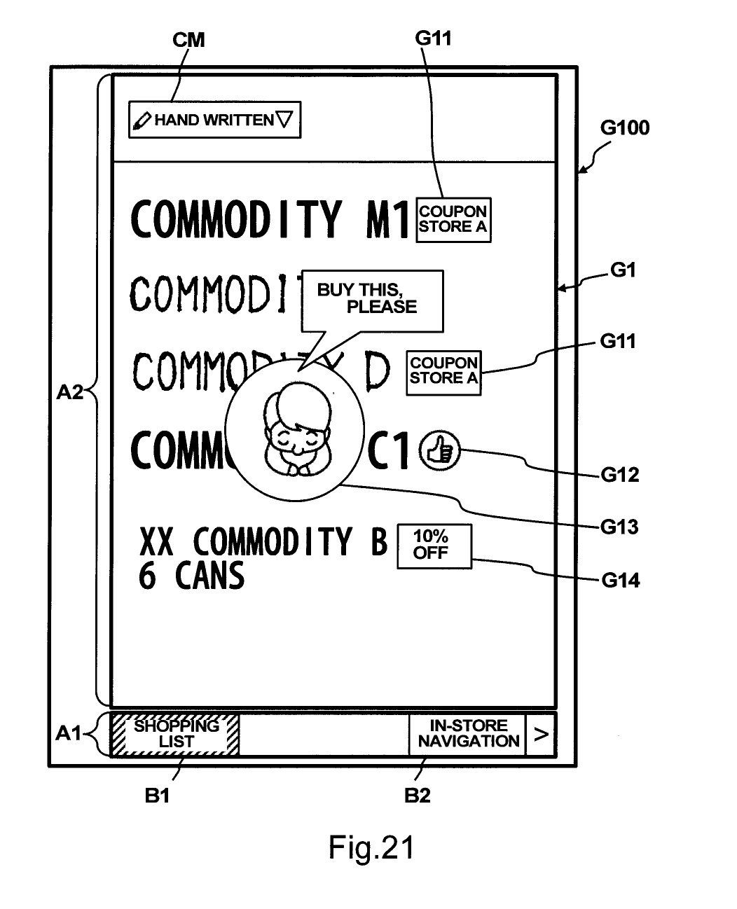

FIG. 20, FIG. 21 are diagrams each showing an example of the shopping list screen G1. When detecting the candidate commodity added with the purchase request information, as described above, the shopping list creation support processor 211 makes the display 23 display the shopping list screen G1, as shown in FIG. 20. The display 23 displays a purchase request icon G13 in the shopping list screen G1, so as to make the screen in the above-described discriminatable state. The purchase request icon G13 includes a character string of “BUY THIS, PLEASE” indicating an image and a message of an employee of the store, as shown in FIG. 21, for example. The purchase request icon G13 may be made of an image format capable of performing animation operation, for example.

In addition, the shopping list creation support processor 211 of the customer terminal 2 makes the display 23 display the above-described detected candidate commodity, as shown in FIG. 21. The display 23 displays a character string of the commodity name of the above-described detected candidate commodity, “XX commodity B, 6 cans” in FIG. 21, for example, in a prescribed typeface. For example, when the additional information (electronic coupon, for example) is made to correspond to the above-described detected candidate commodity, the shopping list creation support processor 211 makes the display 23 display a coupon icon G14 indicating an electronic icon. According to the display of the above-described detected candidate commodity, it is preferable to erase the purchase request icon G13.

As described above, according to the second creation support processing, the shopping support system 1 can take the sales commodity which is guided and advertised in the signage terminal 6 into the shopping list, as the candidate commodity, with a simple operation. Accordingly, the shopping support system 1 can effectively advice purchase of the sales commodity which is guided and advertised in the signage terminal 6 to the customer, and can achieve sales promotion of the sales commodity.

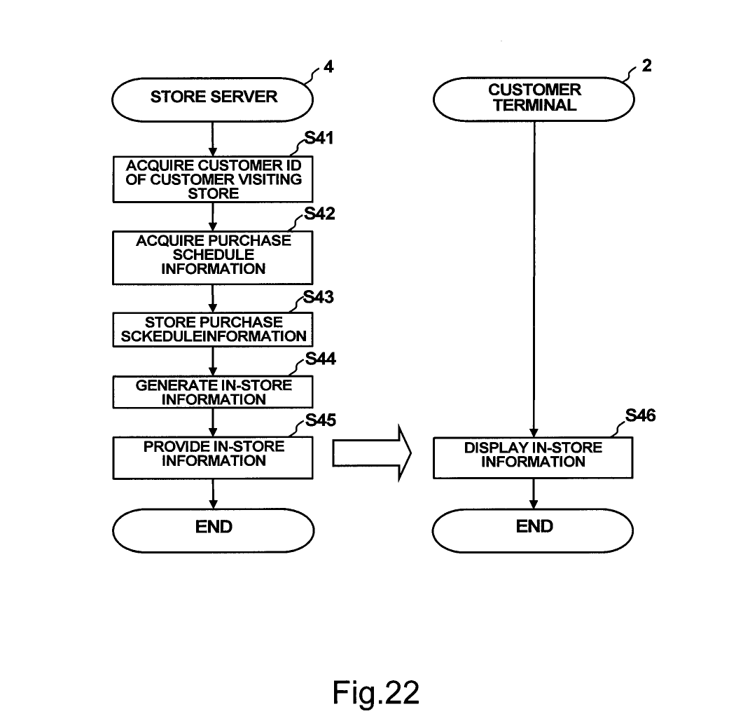

Hereinafter, a shopping support processing which is performed in a store will be described with reference to FIG. 22 to FIG. 24. FIG. 22 is a flow chart showing a shopping support processing. Regarding the shopping support processing, it is presupposed that a customer to visit a store brings the customer terminal 2 in which the own customer ID is held.

As shown in FIG. 22, a processing step S41 of the store server 4, the customer ID acquisition processor 414 of the store server 4 acquires the customer ID from the customer terminal 2 of a customer visiting the store, via a communication device (not shown) in the store connected to the store server 4. The class and installation position of the above-described communication device in not particularly limited. For example, the customer ID acquisition processor 414 acquires the customer ID from the customer terminal 2, via the near field communication device such as an NFC provided at an entrance of the store or an entrance of a parking lot, or the like. Furthermore, the customer ID acquisition processor 414 may acquire the customer ID from the customer terminal 2, via an access point which provides public wireless LAN service and so on in the store.

When the customer ID acquisition processor 414 acquires the custom ID, the processing of the shopping support system 1 proceeds to a processing step S42 of the store server 4. In the step S42, the purchase schedule acquisition processor 415 of the store server 3 acquires the purchase schedule information corresponding to the custom ID acquired by the customer ID acquisition processor 414. The acquisition destination of the purchase schedule information may be made to be the customer terminal 2, or may be made to be the center server 3. For example, when the store server 4 acquires the purchase schedule information from the customer terminal 2, the purchase schedule acquisition processor 415 acquires the purchase schedule information from the customer terminal 2, via the same communication device as that at the time of acquisition of the above described customer ID. Furthermore, when the store server 4 acquires the purchase schedule information from the center server 3, the purchase schedule acquisition processor 415 acquires the purchase schedule information corresponding to the above-described acquired custom ID (refer to the step S41), from the shopping list management table T1 of the center server 3, via the communication I/F 44

When the purchase schedule acquisition processor 415 acquires the above-described purchase schedule information, the processing of the shopping support system 1 proceeds to a processing step S43 of the store server 4. In the step S43, the purchase schedule acquisition processor 415 of the store server 4 stores the above-described acquired purchase schedule information, corresponding to the above-described acquired customer ID, and the current date and time (visiting date and time of a customer), using the purchase commodity management table T4 of the storage unit 45. For example, the purchase schedule acquisition processor 415 controls the storage operation of the storage unit 45, so as to store the above-described acquired purchase schedule information, using the storage unit 45. The purchase commodity management table T4 of the storage unit 45 stores the above-described acquired purchase schedule information corresponding to the above-described acquired customer ID, the current date and time (visiting date and time of a customer).

When the purchase schedule acquisition processor 415 stores the above-described acquired purchase schedule information, using the purchase commodity management table T4, the processing of the shopping support system 1 proceeds to a processing step S44 of the store server 4. In the step S44, the in-store information provision processor 416 of the store server 4 generates in-store information including the advertisement information for advertising a specific commodity and shopping support information for shopping support, and so on. When the in-store information provision processor 416 generates the in-store information, the processing of the shopping support system 1 proceeds to a processing step S45 of the store server 4. In the step S45, the in-store information provision processor 416 provides the customer terminal 2 of the above acquired custom ID (refer to the step S41) with the above-described created in-store information. For example, the in-store information provision processor 416 transmits the in-store information to the customer terminal 2, via the same communication device as that at the time of acquisition of the above-described customer ID.

In the above-described step S45, the advertisement information and the shopping support information included in the in-store information which the in-store information provision processor 416 provides to the customer terminal 2 may be generated based on the purchase schedule information (refer to the step S42) which the purchase schedule acquisition processor 415 has acquired. For example, the in-store information provision processor 416 generates advertisement information for advertising each of the candidate commodities included in the above acquired purchase schedule information (refer to the step S42). In addition, the in-store information provision processor 416 generates shopping support information indicating at what place the candidate commodity included in the above acquired purchase schedule information (refer to the step S42) is sold in the store. Specifically, the in-store information provision processor 416 has map information which records the selling positions of the respective commodities sold in the store, for example. The in-store information provision processor 416 specifies the selling positions of the candidate commodities included in the above acquired purchase schedule information (refer to the step S42), based on this map information. The in-store information provision processor 416 specifies the selling positions, to generate map information which records the selling positions of the candidate commodities included in the above acquired purchase schedule information (refer to the step S42), as the shopping support information

Information to be included in the in-store information is not limited to the above-described example. For example, when privilege such as point imparting is imparted under condition of visiting a store of a customer, the in-store information provision processor 416 includes an electronic coupon to instruct to impart the privilege in the in-store information.

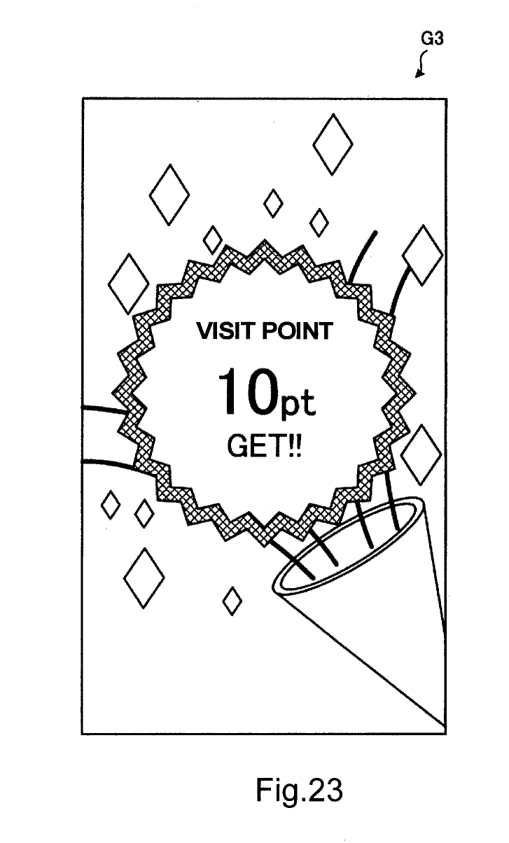

When the in-store information provision processor 416 transmits the above-described in-store information to the customer terminal 2, the processing of the shopping support system 1 proceeds to a processing step S46 of the customer terminal 2. In the step S46, when receiving the in-store information from the store server 4, the shopping support processor 212 of the customer terminal 2 displays the above-described in-store information, using the display 23, according to a customer's operation and so on. For example, the shopping support processor 212 controls the display operation of the display 23, so as to display the above-described in-store information, using the display 23. The display 23 is controlled by the shopping support processor 212, to display the above-described in-store information. In addition, when the above-described electronic coupon is included in the shopping support information, for example, the display 23 is controlled by the shopping support processor 212, to display a privilege imparting screen G3 in accordance with the content of the above-described electronic coupon. FIG. 23 is a diagram showing an example of the privilege imparting screen G3. The display 23 displays a privilege imparting screen G3 shown in FIG. 23 in the second area A2 of the shopping list creation screen G100 (refer to FIG. 12). The display 23 displays a character string of “VISIT POINT 10pt GET” in the privilege imparting screen G3 as shown in FIG. 23, as a message for indicating that the point equivalent to 10 points has been imparted by visiting the store, for example.

Furthermore, when in the in-store information, the above-described map information is included as the shopping support information, the shopping support processor 212 of the customer terminal 2, in accordance with the acceptance of a prescribed operation of a customer, displays a shopping support screen G4 indicating selling positions of the candidate commodities included in the above acquired purchase schedule information (refer to the step S42), using the display 23. For example, when the button B2 which is displayed in the first area A1 of the shopping list creation screen G100 (refer to FIG. 12) accepts a touch operation of the customer, the display 23 displays the shopping support screen G4.

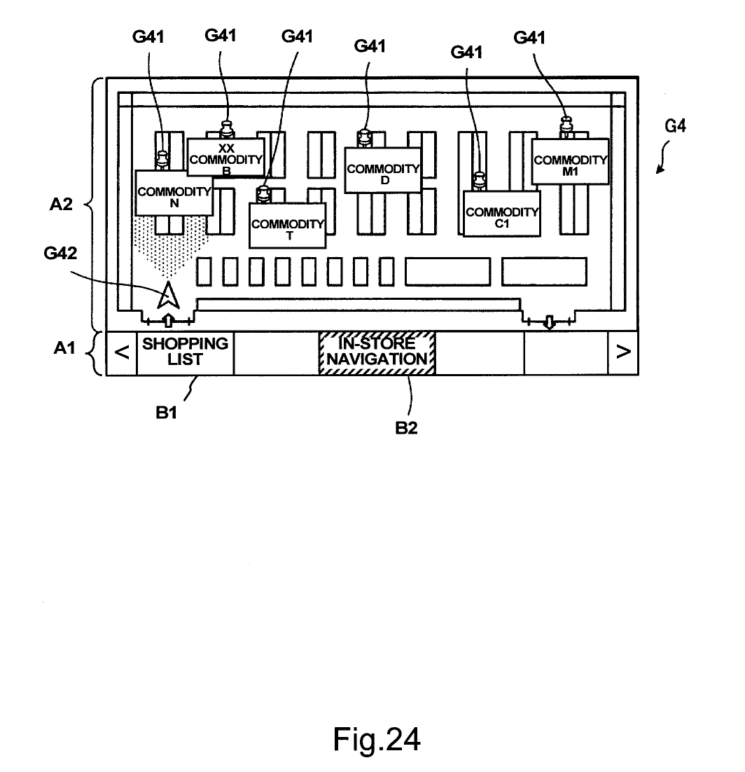

FIG. 24 is a diagram showing an example of the shopping support screen G4. The display 23 displays the shopping support screen G4 in the second area A2 of the shopping list creation screen G100 (refer to FIG. 12), as shown in FIG. 24. The shopping support screen G4 includes a map image showing the inside of the store, as shown in FIG. 24. Furthermore, the shopping support screen G4 includes character strings indicating commodity names of the respective candidate commodities which are displayed on this map image, such as “commodity N”, “XX commodity B”, “commodity T”, “commodity D”, “commodity C1” and “commodity M1”. Furthermore, the shopping support screen G4 includes selling position icons G41 which are displayed along with the above-described commodity names, and show selling positions of the respective candidate commodities.

In addition, when it is possible to specify the current position and direction of the customer terminal 2 by the position specifying device and so on provided in the store, the shopping support screen G4 may include a current position icon G42 showing the current position of the own device (customer terminal 2) and the direction of the own device in the store.

As described above, according to the shopping support processing, the shopping support system 1 can present the selling positions in the store of the candidate commodities included in the shopping list (purchase schedule information) to the customer, via the customer terminal 2. Accordingly, the shopping support system 1 can support the purchase of the candidate commodity in the store, and can improve the convenience of the customer pertaining to the shopping, and can achieve visiting promotion to the store.

In the step S42 of the above-described shopping support processing, the in-store information provision processor 416 acquires the purchase schedule information from the customer terminal 2, when the customer visits the store. Furthermore, in the step S43, the in-store information provision processor 416 stores the acquired purchase schedule information, using the purchase commodity management table T4 of the storage unit 43. On the other hand, the in-store information provision processor 416 may also acquire the additional information, and may store the acquired additional information, using the purchase commodity management table T4 of the storage unit 43. When storing the above-described additional information, the in-store information provision processor 416 can deal with the storing of the additional information, by adding a data area to store the additional information in the purchase commodity management table T4.

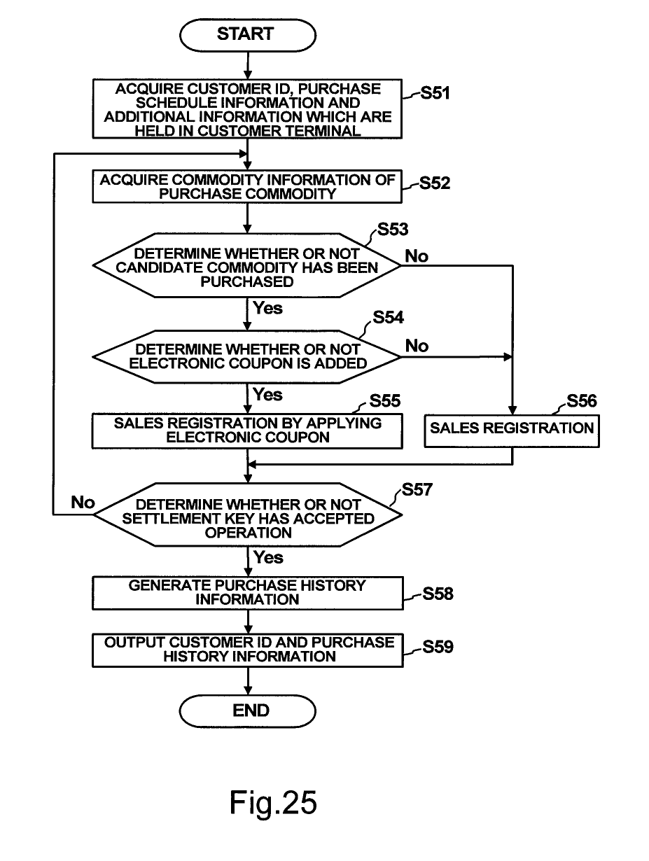

Hereinafter, commodity sales data processing which the POS terminal 5 of the shopping support system 1 performs when a customer purchases a commodity will be described with reference to FIG. 25. FIG. 25 is a flow chart showing the commodity sales data processing.

As shown in FIG. 25, in a step S51, the terminal information acquisition processor 511 of the POS terminal 5 acquires the customer ID, the purchase schedule information and the additional information which are held in the customer terminal 2, from the customer terminal 2. A method of acquiring the customer ID, the purchase schedule information and the additional information by the terminal information acquisition processor 511 is not limited. For example, the terminal information acquisition processor 511 may directly acquire the customer ID, the purchase schedule information and the additional information from the customer terminal 2, using the near field communication I/F 57. Furthermore, the terminal information acquisition processor 511 may acquire the purchase schedule information and the additional information which are stored corresponding to the customer ID, from the purchase commodity management table T4 of the storage unit 45, using the customer ID acquired from the customer terminal 2 as a search fee.

When the terminal information acquisition processor 511 acquires the customer ID, the purchase schedule information and the additional information, the processing of the POS terminal 5 proceeds to a processing step S52. In the step S52, the commodity information acquisition processor 512 of the POS terminal 5 acquires commodity information of an actual purchase commodity. For example, the commodity information acquisition processor 512 controls the read operation of the code scanner 55, so as to acquire the commodity information of the purchase commodity, using the code scanner 55. The code scanner 55 scans the actual purchase commodity, to read the commodity ID attached to the purchase commodity. The commodity information acquisition processor 512 acquires the commodity information stored corresponding to the above read commodity ID, from the commodity management table T3. The commodity information includes a commodity name and a unit price and so on of the purchase commodity.

When the commodity information acquisition processor 512 acquires the commodity information of the purchase commodity, the processing of the POS terminal 5 proceeds to a processing step S53. In the step S53, the sales registration processor 513 of the POS terminal 5 determines whether or not the candidate commodity included in the shopping list has been purchased. Specifically, the sales registration processor 513 compares the commodity names of the purchase commodity included in the above acquired commodity information with the commodity names of the candidate commodity included in the shopping list, respectively. The sales registration processor 513 determines, based on this comparison result, whether or not the commodity name of the purchase commodity included in the above acquired commodity information coincides with the commodity name of the candidate commodity included in the shopping list. When the sales registration processor 513 determines that the commodity other than the candidate commodity has been purchased (No, in Step S53), the processing of the POS terminal 5 proceeds to a processing step S56. In the step S56, the sales registration processor 513 performs sales registration of the purchase commodity, based on the acquired commodity information.

When the sales registration processor 513 determines that the candidate commodity has been purchased, in the above-described step S53 (Yes, in step S53), the processing of the POS terminal 5 proceeds to a step S54. In the step S54, the sales registration processor 513 determines whether or not the electronic coupon which is provided from the own store is added to the above purchased candidate commodity, as the additional information. For example, the sales registration processor 513 determines whether or not the electronic coupon is added to the above purchased candidate commodity, with reference to the above acquired additional information (step S51). When the sales registration processor 513 determines that the electronic coupon is added to the above purchased candidate commodity (Yes in step S54), the processing of the POS terminal 5 proceeds to a processing step S55. In the step S55, the sales registration processor 513 performs sales registration of the purchase commodity at a unit price applied with the above-described electronic coupon. When the sales registration processor 513 determines that the electronic coupon is not added to the above purchased candidate commodity (No in step S54), the processing of the POS terminal 5 proceeds to a processing step S56. In the step S56, the sales registration processor 513 performs sales registration of the purchase commodity at a usual unit price included in the commodity information.

When the sales registration processor 513 performs sales registration in the above-described step S55 or the above-described step S56, the processing of the POS terminal 5 proceeds to a processing step S57. In the step S57, the controller 51 of the POS terminal 5 determines whether or not the settlement key of the operation panel 42 has accepted an operation of a store employee. When the controller 51 determines that the settlement key of the operation panel 42 has not accepted the operation of the store employee (No, in Step 57), the processing of the POS terminal 5 returns to the above-described step S52. The POS terminal 5 repeatedly executes the processings of the above-described step S52—the above-described step S56, till the controller 51 determines that the settlement key of the operation panel 42 has accepted the operation of the store employee. When the controller 51 determines that the settlement key of the operation panel 42 has accepted the operation of the store employee (Yes, in Step 57), the processing of the POS terminal 5 proceeds to a processing step S58. In the step S58, the purchase history generation processor 514 of the POS terminal 5 generates purchase history information showing items of transaction in which sales registration for the whole purchase commodities has been finished. The purchase history information includes a commodity name, a commodity ID and a unit price and so on of the purchase commodity

When the purchase history generation processor 514 generates the purchase history information, the processing of the POS terminal 5 proceeds to a processing step S59. In the step S59, the purchase history output processor 515 of the POS terminal 5 outputs the above generated purchase history information. For example, the purchase history output processor 515 controls the communication operation of the communication I/F 56, so as to transmit the above generated purchase history information to the store server 4, using the communication I/F 56. The communication I/F 56 is controlled by the purchase history output processor 515, to transmit the above generated purchase history information to the store server 4. In addition, the purchase history output processor 515 controls the printing operation of the printer 54, so as to print a receipt based on the above created purchase history information, using the printer 54. The printer 54 prints the receipt, based on the above generated purchase history information.

As described above, according to the commodity sales data processing, the shopping support system 1 can apply the electronic coupon which has been provided from the store at the time of creating the shopping list, when a customer purchases the candidate commodity. Accordingly, the customer who purchases the candidate commodity can enjoy the privilege provided at the time of creating the shopping list, without any consideration. Furthermore, the shopping support system 1 can prevent the customer from forgetting to use the electronic coupon. Furthermore, the shopping support system 1 can improve the convenience pertaining to the purchase of the candidate commodity.

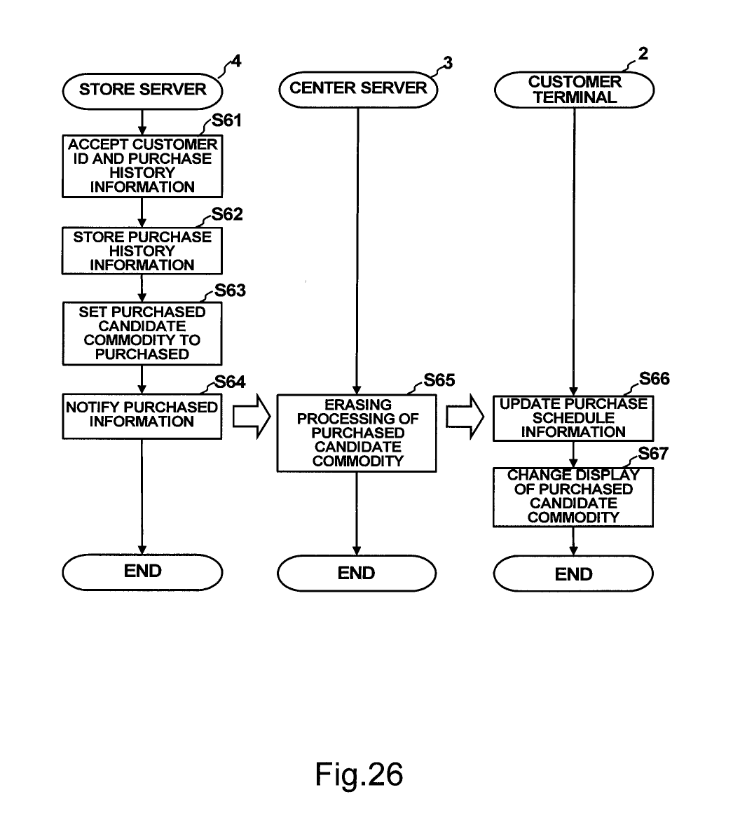

Hereinafter, erasing processing of the candidate processing which is executed after the purchase of the candidate commodity by the customer will be described with reference to FIG. 26. FIG. 26 is a flow chart showing the candidate commodity erasing processing.

As shown in FIG. 26, in a processing step S61 of the store server 4, the purchase history management processor 417 of the store server 4 accepts the customer ID and the purchase history information from each POS terminal 5 in the store. For example, the purchase history management processor 417 controls the communication operation of the communication I/F 44, so as to receive the customer ID and the purchase history information, using the communication I/F 44. The communication I/F 44 is controlled by the purchase history management processor 417, to receive the customer ID and the purchase history information from each POS terminal 5 in the store. When the purchase history management processor 417 receives the above-described customer ID and purchase history information, the processing of the shopping support system 1 proceeds to a step S62 of the store server 4. In the step S62, the purchase history management processor 417 stores the purchase history information, corresponding to the above-described customer ID, using the second purchase history management table T5 of the storage unit 45. Furthermore, when storing the purchase history information, corresponding to the above-described customer ID, the purchase history management processor 417 adds the store ID of the own store.

When the purchase history management processor 417 stores the above-described customer ID and purchase history information, using the storage unit 45, the processing of the shopping support system 1 proceeds to a processing step S63 of the store server 4. In the step S63, the purchased setting processor 418 sets the candidate commodity which has actually been purchased to the purchased, out of the candidate commodities included in the purchase schedule information stored in the second purchase history management table T5 of the storage unit 45. For example, the purchased setting processor 418, regarding the same customer ID, compares the purchase commodity included in the above stored purchase history information (step S62), with the candidate commodity included in the purchase schedule information of the purchase commodity management table T4. The purchased setting processor 418, regarding the candidate commodity with the name which coincides with a commodity name (concrete, common name) of the purchase commodity, sets a purchased flag to the purchased information of the purchase commodity management table T4.

When the purchased setting processor 418 of the store server 4 sets the purchased candidate commodity to the purchased, the processing of the shopping support system 1 proceeds to a processing step S64 of the store server 4. In the step S64, the purchased setting processor 418 of the store server 4 notifies the center server 3 of the purchased information of the candidate commodity to which the above-described purchased flag has been set, along with the corresponding customer ID. For example, the purchased setting processor 418 controls the communication operation of the communication I/F 44, so as to transmit the purchased information of the candidate commodity and the corresponding customer ID, using the communication I/F 44. The communication I/F 44 is controlled by the purchased setting processor 418, to transmit the purchased information of the candidate commodity and the corresponding customer ID, to the center server 3.

When the purchased setting processor 418 notifies the center server 3 of the purchased information of the candidate commodity and the corresponding customer ID, the processing of the shopping support system 1 proceeds to a processing step S65 of the center server 3. In the step S65, the erasing processing processor 314 of the center server 3 accepts the above-described customer ID the purchased information from the store server 4. For example, the erasing processing processor 314 controls the communication operation of the communication I/F 34, so as to receive the above-described customer ID and purchased information, using the communication I/F 34. The communication I/F 34 is controlled by the erasing processing processor 314, to receive the above-described customer ID and the purchased information from the store server. The erasing processing processor 314 executes the erasing processing of the candidate commodity which has been set to the above-described purchased, based on the above-described customer ID and purchased information which have been accepted as described above, from the purchase schedule information of the shopping list management table T1 corresponding to the customer ID. The erasing processing may be a processing to erase the relevant candidate commodity from the purchase schedule information, for example, or may be a processing to add flag information and so on indicating the purchased, to the relevant candidate commodity.

Furthermore, in the above-described step S65, the erasing processing processor 314 of the center server 3 transmits the purchase schedule information in which the erasing processing of the above-described candidate commodity has been executed, to the customer terminal 2 holding the corresponding customer ID, using the communication I/F 34. Specifically, the erasing processing processor 314 controls the communication operation of the communication I/F 34, so as to transmit the purchase schedule information in which the erasing processing of the above-described candidate commodity has been executed, using the communication I/F 34. The communication I/F 34 is controlled by the erasing processing processor 314, to transmit the purchase schedule information in which the erasing processing of the above-described candidate commodity has been executed, to the customer terminal 2 holding the corresponding customer ID. When the erasing processing processor 314 executes the erasing processing of the purchased candidate commodity from the purchase schedule information, and transmits the purchase schedule information in which the erasing processing of the purchased candidate commodity has been executed, to the customer terminal 2, the processing of the shopping support system 1 proceeds to a processing step S66 of the customer terminal 2. In the step S66, the shopping list creation support processor 211 of the customer terminal 2 accepts the purchase schedule information in which the erasing processing of the above-described candidate commodity has been executed, using the communication I/F 26. For example, the shopping list creation support processor 211 controls the communication operation of the communication I/F 26, so as to receive the purchase schedule information in which the erasing processing of the above-described candidate commodity has been executed, using the communication I/F 26. The communication I/F 26 is controlled by the shopping list creation support processor 211, to receive the purchase schedule information in which the erasing processing of the above-described candidate commodity has been executed, from the center server 3. The shopping list creation support processor 211 updates the purchase schedule information which is locally stored in the storage unit 28, based on the purchase schedule information in which the erasing processing of the above-described candidate commodity has been executed. When the shopping list creation support processor 211 updates the purchase schedule information, the processing of the shopping support system 1 proceeds to a processing step S67 of the customer terminal 2. In the step S67, the shopping list creation support processor 211 of the customer terminal 2 changes the display of the purchased candidate commodity in the shopping list screen G1, based on the purchase schedule information in which the erasing processing of the above-described candidate commodity has been executed.

For example, when the purchased candidate commodity is erased from the purchase schedule information, by the erasing processing of the center server 3, the shopping list creation support processor 211 of the customer terminal 2 controls the display operation of the display 23, so as to hide the relevant candidate commodity in the above-described shopping list screen G1, using the display 23. The display 23 is controlled by the shopping list creation support processor 211, to hide the relevant candidate commodity in the above-described shopping list screen G1. For example, when the flag information indicating the purchased is added to the purchased candidate commodity, by the erasing processing of the center server 3, the shopping list creation support processor 211 displays so as to clearly express that the relevant candidate has been purchased in the shopping list screen G1. For example, the shopping list creation support processor 211 controls the display operation of the display 23, so as to display the relevant candidate commodity in the above-described shopping list screen G1 with a strikethrough and so on added. The display 23 is controlled by the shopping list creation support processor 211, to display the relevant candidate commodity in the above-described shopping list screen G1 with a strikethrough and so on added.

As described above, according to the candidate commodity erasing processing, when the candidate commodity has been actually purchased, the shopping support system 1 can delete the relevant candidate commodity from the shopping list, and can notify that the relevant candidate commodity has been purchased on the shopping list to the customer. Accordingly, the shopping support system 1 can reflect the purchase state of the candidate commodity on the shopping list, and can thereby improve the convenience pertaining to the purchase of the candidate commodity.

In the above-described candidate commodity erasing processing, the shopping support system 1 updates the purchase schedule information of the customer terminal 2, in accordance with the update of the purchase schedule information of the center server 3. On the other hand, the customer terminal 2 may directly update the purchase schedule information of the own device. For example, in the above-described commodity sales data processing of the POS terminal 5, the customer terminal 2 can directly update the purchase schedule information of the own device, by executing the erasing processing of the candidate commodity included in the purchase schedule information of the own device.

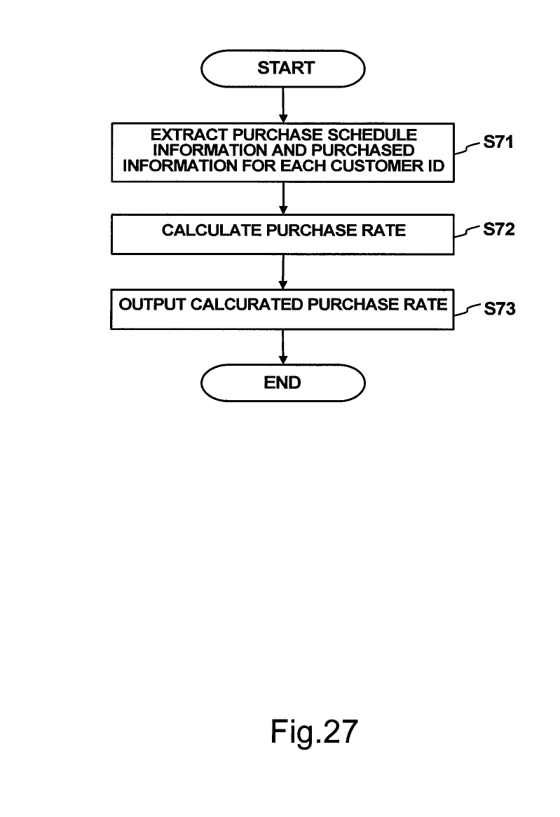

Hereinafter, an analysis processing which the analysis processing processor 419 of the store server 4 executes will be described with reference to FIG. 27. The analysis processing processor 419 analyzes the property of each customer, and the relation between the candidate commodity and the actual purchase commodity and so on, based on the data stored in the purchase commodity management table T4. In the following description, an analysis processing to analyze the property of each customer will be described, as an example of an analysis processing which the analysis processing processor 419 of the store server 4 executes.

FIG. 27 is a flow chart showing an analysis processing which the analysis processing processor 419 of the store server 4 executes. As shown in FIG. 27, in a processing step S71 of the store server 4, the analysis processing processor 419 of the store server 4 extracts the purchase schedule information and the purchased information stored in the purchase commodity management table 4, for each customer ID. When the analysis processing processor 419 extracts the purchase schedule information and the purchased information, for each customer ID, the processing of the store server 4 proceeds to a processing step S72. In the step S72, the analysis processing processor 419 calculates a ratio of the candidate commodities in which the purchased flag has been set in the purchased information, to the whole commodities included in the extracted purchase schedule information, as a purchase rate. When the analysis processing processor 419 calculates the purchase rate, the processing of the store server 4 proceeds to a processing step S73. In the step S73, the analysis processing processor 419 outputs the calculated purchase rate of each customer (customer ID), as the analysis result, using the display 43 or the like.

As described above, according to the analysis processing, the store server 4 of the shopping support system 1 can grasp in what extent the candidate commodities are purchased in the own store, out of the candidate commodities which each customer has included in the shopping list. In addition, the store provides service (electronic coupon, and so on) in accordance with the customer, based on the purchase rate of each customer obtained as the analysis result, and thereby can further achieve promotion of visiting the store of customers.

A program for the processing executed in each terminal of the shopping support system may be provided to the shopping support system, in a state where the program is previously stored in a ROM, a storage unit or the like. The above-described program may be provided to the shopping support system, in a state where the program is recorded in a computer readable recording medium, such as a CD-ROM, a flexible disk (FD), a CD-R, a DVD, in a file of an installable form or an executable form.

The above-described program may be stored in a computer connected to a network such as Internet, and the program may be provided to the shopping support system, by being downloaded from this computer via the network. Furthermore, the above-described program may be provided or distributed to the shopping support system, via a network such as Internet.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. In a shopping support system having a plurality of customer terminals and a center server, the shopping support system comprising:
an input acceptance unit, provided in the customer terminal, which accepts an input of a candidate commodity to become a purchase candidate;
a customer terminal controller, provided in the customer terminal, which transmits purchase schedule information including the candidate commodity to be accepted by the input acceptance unit of the customer terminal, to the center server; and
a center server controller, provided in the center server, which receives the purchase schedule information transmitted from the customer terminal controller, and notifies a store to sell the candidate commodity included in the received purchase schedule information, of the candidate commodity.

2. The shopping support system according to claim 1, wherein the customer terminal controller has a shopping list creation support processor which generates the purchase schedule information including the candidate commodity to be accepted by the input acceptance unit of the customer terminal, and transmits the generated purchase schedule information to the center server, using a communication interface which the customer terminal has.

3. The shopping support system according to claim 2, wherein the center server controller has a mediation processor which receives the purchase schedule information from the shopping list creation support processor, using a communication interface which the center server has, and notifies the store of the candidate commodity included in the purchase schedule information, using the communication interface which the center server has.

4. The shopping support system according to claim 3, wherein:
the center server has a storage unit to store purchase history information in each store which an operator to operate the customer terminal has utilized; and
the mediation processor selects a store of a notice destination which is notified of the candidate commodity, based on the purchase history information stored by the storage unit.

5. The shopping support system according to claim 3, wherein the mediation processor receives additional information relating to the notified candidate commodity, from the notified store, using the communication interface which the center server has.

6. The shopping support system according to claim 5, wherein the mediation processor transmits the additional information relating to the candidate commodity which is received from the store, to the customer terminal, using the communication interface which the center server has.

7. The shopping support system according to claim 5, wherein the input acceptance unit of the customer terminal accepts the candidate commodity which is expressed by any name of a concrete name and a common name.

8. The shopping support system according to claim 7, wherein the input acceptance unit of the customer terminal accepts the candidate commodity, in accordance with a plurality of input modes.

9. The shopping support system according to claim 8, wherein a plurality of the input modes have a handwritten character input mode, a sound input mode, a key input mode, and an image input mode.

10. The shopping support system according to claim 7, wherein the input acceptance unit of the customer terminal accepts the candidate commodity which is inputted from an external device.

11. The shopping support system according to claim 9, wherein the customer terminal has a display unit to display a shopping list screen for displaying the candidate commodity which has been accepted by the input acceptance unit of the customer terminal.

12. The shopping support system according to claim 11, wherein when the input mode is the handwritten character input mode, the display unit functions as the input acceptance unit of the customer terminal.

13. The shopping support system according to claim 12, wherein the display unit displays the candidate commodity expressed by a handwritten character which has been inputted with a handwritten character in the shopping list screen.

14. The shopping support system according to claim 11, wherein the shopping list creation support processor receives the additional information from the mediation processor using the communication interface which the customer terminal has, and updates a display content of the shopping list screen which the display unit displays, based on the received additional information.

15. The shopping support system according to claim 14, wherein the shopping list creation support processor displays the additional information in the shopping list screen, using the display unit.

16. The shopping support system according to claim 14, wherein the display unit displays the additional information in the shopping list screen, corresponding to the candidate commodity.
